(19) United States
(12) Patent Application Publication
(10) Pub. No.: US 2011/0082848 A1
(43) Pub. Date: Apr. 7, 2011

(54) SYSTEMS, METHODS AND COMPUTER PROGRAM PRODUCTS FOR SEARCH RESULTS MANAGEMENT

(76) Inventor: Lev GOLDENTOUCH, Rishon Lezion (IL)

(21) Appl. No.: 12/573,331

(22) Filed: Oct. 5, 2009

(51) Int. Cl. G06F 17/30

(52) U.S. Cl. 707/706; 707/728; 707/E17.014; 707/E17.108

(57) ABSTRACT

A system, including: (a) an input interface configured to receive from a search engine information that pertains to at least one document, wherein the at least one document is selected by the search engine in response to at least one search query; (b) a data structure module, connected to the input interface, which is configured to divide the at least one document into multiple granular elements in response to content of the at least one document; (c) a ranking module, connected to the input interface, which is configured to the granular elements in response to query parameters, and (d) an output interface, connected to the ranking module, which is configured to provide, in response to the ranking of the granular elements, search results that include at least one of the ranked granular elements.

### BACKGROUND OF THE INVENTION

Several widely used search systems are known in the art, e.g. Google™ web search, Google Desktop™, Ask.com™ semantic search engines, etc. The search engines provide formatted search results to user queries. The search results may be clustered together using Picitup™ or SurfCanyon™ extensions.

On the other hand there are professional knowledge management systems, such as corporate portals, ERP and Sharepoint™. Knowledge management systems can be used for a wide range of cooperative, collaborative, adhocracy and hierarchy communities, virtual organizations, societies and other virtual networks, to manage media contents; activities, interactions and work-flows purposes; projects; works, networks, departments, privileges, roles, participants and other active users in order to extract and generate new knowledge and to enhance, leverage and transfer in new outcomes of knowledge providing new services using new formats and interfaces and different communication channels.

There may be a need in dedicated search results management tools, bridging the gap between search and knowledge management.

### SUMMARY OF THE INVENTION

A method, including: (a) receiving from a search engine information that pertains to at least one document, wherein the at least one document is selected by the search engine in response to at least one search query; (b) dividing the at least one document into multiple granular elements in response to content of the at least one document; (c) ranking the granular elements in response to query parameters, and (d) providing, in response to the ranking of the granular elements, search results that include at least one of the ranked granular elements.

A system, including: (a) an input interface configured to receive from a search engine information that pertains to at least one document, wherein the at least one document is selected by the search engine in response to at least one search query; (b) a data structure module, connected to the input interface, which is configured to divide the at least one document into multiple granular elements in response to content of the at least one document; (c) a ranking module, connected to the input interface, which is configured to the granular elements in response to query parameters, and (d) an output interface, connected to the ranking module, which is configured to provide, in response to the ranking of the granular elements, search results that include at least one of the ranked granular elements.

A computer readable medium, having a computer readable code embodied therein for data managing, the computer readable code including instructions for: (a) receiving from a search engine information that pertains to at least one document, wherein the at least one document is selected by the search engine in response to at least one search query; (b) dividing the at least one document into multiple granular elements in response to content of the at least one document; (c) ranking the granular elements in response to query parameters, and (d) providing, in response to the ranking of the granular elements, search results that include at least one of the ranked granular elements.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1A illustrates a method, according to an embodiment of the invention;

FIG. 2B illustrate a system, according to an embodiment of the invention;

FIG. 2A presents integration of a proposed search results management system, according to an embodiment of the invention;

FIG. 2B presents a design of a search results management system, according to an embodiment of the invention;

FIG. 3 presents business logic method, according to an embodiment of the invention;

FIG. 4 presents processing algorithms, according to an embodiment of the invention;

FIG. 5 presents search engine interface method, according to an embodiment of the invention;

FIG. 6 presents data caching methods, according to embodiments of the invention;

FIG. 7 presents annotation and messaging methods, according to embodiments of the invention;

FIG. 8 presents user portfolio management method, according to an embodiment of the invention;

FIG. 9 presents client software methods, according to embodiments of the invention.

FIG. 10 presents billing interface methods, according to embodiments of the invention;

FIG. 11 presents mobile application methods, according to embodiments of the invention;

FIG. 12 presents e-commerce application methods, according to embodiments of the invention;

FIG. 13 presents research application methods, according to embodiments of the invention;

FIG. 14 presents search results display, according to an embodiment of the invention;

FIG. 15 presents article content display, according to an embodiment of the invention; and

FIG. 16 presents messaging display, according to an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

It is noted that the disclosure offers different embodiments of the invention, and that not all the features and implementations discussed below are incorporated into each embodiment.

It is noted that the inventions discussed herein may be combined with systems and methods discussed in the following publications by the same inventor, all of which are incorporated in its entirety herein by reference—
i. U.S. Provisional Patent Application Ser. No. 61/042,564, filed on Apr. 4, 2008, entitled “System, Methods and Applications for Web Content Storage, Marking and Sharing”;
ii. U.S. patent application Ser. No. 12/416,947, filed on Apr. 2, 2009, entitled “Systems, Methods and Computer Program Products for Content Management”;
iii. U.S. Provisional Patent Application Ser. No. 61/084,633, filed on Jul. 30, 2008, entitled “System, Methods and Applications for Structured Document Indexing”;
iv. U.S. patent application Ser. No. 12/511,747, filed Jul. 29, 2009, entitled “System, Methods and Applications for Structured Document Indexing”.

Few definitions are provided, solely to assist one of ordinary skills in the art to better understand the following disclosure. As such, these definitions should not be used to limit the scope of the disclosure more narrowly that the plain and ordinary meaning of the terms recited in the claims. With that caveat, the following definitions are used:
i. “Browser” means an Internet browser capable of displaying formatted content such as, by way of illustration, HTML, WML, flash and proprietary XML, and scripts formats.
ii. “Browsing experience” means a user subjective experience when using the browser. The term includes, by way of illustration, web navigation, browsing history, bookmarks, security, and automation. Examples of automation, by way of illustration, include single sign on and macros.
iii. “Browsing history” means content which the user has already accessed by the browser, and which may be available for re-visiting in the future.
iv. “Client” is a computational facility which enables a browser and the browser's graphical capabilities.
v. “Computational facility” is a computer, embedded processor, co-processor, computer network or other device capable of digital signal processing and digital communication.
vi. “Computer language” is a protocol or format used within a computational facility or between computational facilities, including, by way of illustration, programming languages (such as Java), markup languages (such as DHTML), and communication protocols (such as HTTP).
vii. “Device” means a machine employing one or more digital processing units. The term includes, by way of illustration, a personal computer, a cellular phone, a PDA, an IPTV, a Play-station, and other devices employing digital processing units.
viii. “Hosted service” means a service operated by a dedicated authority, in which said authority operates as a proxy to provide the service to all relevant customers. Examples of dedicated authorities include, by way of illustration, Internet service providers for personal PCs, cellular operators for mobile devices, and IPTV operators for IPTV-based internet access.
ix. “HTML” means an embodiment of formatted content adjusted for display in a browser, including, by way of illustration, HTML, WML, flash and proprietary XML, and scripts formats.
x. “Local device” means a device, for which the user has full administrative rights or has administrative rights related to the devices of other people, including, by way of illustration, personal home computer, personal mobile phone and personal pocket computer.
xi. “National language” is a human language, which would include, by way of illustration, English, Chinese, and Hebrew.
xii. “Network” means an accessing electrical-mechanical communication network, including, by way of illustration, an Internet network (which may be accessed via the World Wide Web or via other means), other public networks, and private networks. Any such networks may be any level of security from none to the highest possible level. Any such networks may cover any geographic area (such as LAN or WAN), with any number or kind of devices on the network. Any such networks may be one-way in either direction (that is, from network center to remote device, or vice versa), or may be two-way. Any such networks may include various computational facilities. Examples of a “network” include an IPTV network, a TV broadcast network, a mobile telephony network, and a network of security cameras.
xiii. “Object” media means rich media formats, including, by way of illustration, images, audio, video, synthetic graphics, and flash.
xiv. “Plug-in” means a browser plug-in, which is software provided by third party to a browser in order to increase the functional capabilities of the browser.
xv. “Proxy” means a computational facility which stores and/or modifies the content from the server to be used in the browser.
xvi. “Server” means a computational facility which stores formatted content.
xvii. “User” means a human or a computer using the browser.
xviii. “Web” means a system of interlinked web pages accessed via a network, including, by way of illustration, the World Wide Web over the Internet network.
xix. “Web navigation” means various operations required to access specific content. Such operations include, by way of illustration, feeding-in an IP-address, feeding-in a server name, using bookmarks, using forward and backward navigation in browsing history, and using the “home button” on the browser.
xx. “Web page” means an object or document available in the web, including, by way of illustration, HTML documents, RSS feeds, RDF data, Flash objects, video streams, and music streams.
xxi. “XML document” means a document stored in XML format or XML-related formats, including HTML, binary XML, CSS, SOAP, or other suitable document formats.
xxii. “XML tree” means a tree data-structure characteristic for XML document, including DOM models, binary tree, radix tree or other suitable data structures.

Disclosed below are several methods, systems, and computer program products for search results management.

Some embodiments include a system including user interface, search engine interface, database, storage and processing modules. The user interface may be embodies as web portal, plug-in to locally installed software, dedicated service or other suitable interface. The search engine interface may include interface to web search provider, local device search, dedicated search software or other suitable search mechanism. The database may include relational database for user data and native XML database for structured documents. The storage may include flash memory, magnetic or optical storage devices. The processing modules may include business logic, search algorithms, transcoding algorithms, document analysis algorithms or other suitable processing.

Some embodiments enable methods for data collection, analysis, customization and sharing system and methods and built-in integration with search tools.

Method 1: Data collection, including search results caching. It is noted that some or all of the stages of method 1 may be incorporated into method 2500, and especially into stage 2510. The data collection may include collecting search queries, old results and new results, time spent on analyzing each entry, comments on specific entry, ranking, voting, connectivity with previously viewed entries, content of an entry, results of entry analysis. For example, instead of printing out a long report and marking interesting parts with margin notes and stick-it notes, the user may activate web annotation tools, enabling highlighting, comments, ranking and graphical marking of the objects of interest.

Method 2: Search results analysis, including multi-resolution document analysis and search history analysis. Multi-resolution document analysis includes analysis of the whole document, sections of document, paragraphs and images. For each level of the document there may be user marking and automatically calculated statistics. The automatically calculated statistics may include viewing and ranking statistics, keyword search results, semantic analysis cloud, links to other document and other suitable statistics. It is noted that some or all of the stages of method 2 may be incorporated into method 2500, e.g. into stages 2520, 2530, and 2540.

Method 3: Customization, including customization for target device, preferable GUI mode and source information. It is noted that some or all of the stages of method 3 may be incorporated into method 2500

The customization for target device may include transcoding of embedded documents, dividing the document into several smaller documents and mini-pages, providing paragraphs and images from the document without the need to open the document on the client, modifying GUI for technologies supported on local device or other suitable methods.

The selection of preferable GUI mode may include language selection, graphical (for example AIR-based) representation with document preview, simple text from the document, scrollable or searchable paragraphs and images from the document or other suitable search data representation. Source of information may include the internet, personal device, enterprise network, web-site of interest, results of searches performed by other users, results of searches by particular service provider, results of searched in geophysical area, result of search in address book or other suitable data source.

The customization for search information may include different representation for search entries of different sort or with different statistics. For example, results that were viewed by other users in the same user group, include comments or were taken from high-reputation sources may be marked with special symbols.

Method 4: Information sharing. Various sharing methods may be applied to various types of information. For example, particular documents and comments to documents may be sent via e-mail or SMS. For example, the users of people within the group interested in similar subjects may be displayed to the user. For example, user comments may be shared within the group. It is noted that some or all of the stages of method 4 may be incorporated into method 2500

Method 5: Integration with search tools, including search query entry, reading formatted query results, automated suggestion system, auto-completion system integration, billing system integration, user info integration, integration between multiple search tools or other suitable integration. It is noted that some or all of the stages of method 5 may be incorporated into method 2500

The integration of the search results management methods enables several new applications and features, of which few examples are offered, according to some embodiments of the invention.

Feature 1: Spot-mark-link. While searching for information or scrolling through available information the user may spot an object of interest, for example paragraph, table or image. The user may mark the object of interest with graphical mark, annotation text or comment, ranking or other suitable mark. The marked content may be stored for later use or shared with other group members via suitable messaging service.

Feature 2: Relevant content preview. Opening and scrolling some documents requires significant resources on client side, user time and attention. By pre-fetching and preprocessing the required documents on server side, the user may get immediate access to the relevant paragraphs and images of the required document. The preprocessing may include multi-resolution document segmentation into sections, paragraphs and images, followed by search of objects of small interest. These objects of interest found by search algorithm, may be selectively transcoded for presentation in target format, for example as plain HTML. The preview of relevant objects optimizes screen area of small devices, optimizes rendering capability of target device and save time of loading dedicated display program.

Feature 3: Search history sharing. Users of a group, including for example enterprise portal users, may share similar areas of interest. Many users repeat search queries, since it is hard to remember previous query results. There is a high probability that some the search results entries fetched for current query were already fetched previously. For previously fetched results it make sense to show the other users in the group that analyzed the search result entry of interest, amount of attention spent by the user on the search result and user comment/rating if available. This previous search statistics may save time of revisiting the document, enable knowledge exchange between independent contributors and enable alerts on new search results.

Feature 4: Alert and report generation. The users may define a set of queries for analysis and view query results. For entries of interest the users may and comments and marking. The set of queries may be executed periodically and new entries in query result may generate alarms, sent via any suitable messaging service. The statistics of queried results, results with comments and new results may be used to generate reports. For example, if a group of analysts works on some market research, the combined search statistics, comments and analysis and search results of the group may become automatically available to all group members.

Feature 5: Information clustering. The historical search results may be clustered using semantic analysis of search results and attention given to each result. When a new query is entered, the query results may be incrementally clustered to the original results, improving data selectivity. For example, if the user was active in motorbike search activity, and searches the word Toyota™, the Toyota™ motorbikes may be clustered and promoted in the user's search results, above Toyota™ cars and other products. The information clustering may be used to offer the user links associated with promoted links (contextual advertising) or spontaneous information discovery (for example, Stumbleupon™) within the cluster of interest.

It is noted that any one or more of those features may be implemented in various embodiments of method 2500, and/or of system 3000. For example, the features of the invention may be useful for several applications, including by way of illustration:

Application 1: Mobile search. In some embodiments, the user of mobile device generates search query, which is sent to the server. The server passes the query to search engine and collects URLs of the results. The search may be performed on web, personal computer, dedicated web site, enterprise portal or any other suitable data depository. A robot collects the articles referenced by URLs of the results, and divides the article into meaningful objects, including sections, paragraphs and images. The objects of interest are ranked according to the relevance to the query. The high-ranking objects of interest are transcoded into format easily readable by target device and displayed to the user, enabling optimization of bandwidth and display capabilities of the target device. The user may scroll between high-ranking objects or jump to the relevant parts of the article. The navigation between search results and article of interest may be enabled by a plug-in inside the browser of the local device and dedicated anchors inserted by server during the analysis of the article. In some embodiments, the article is transcoded to the formats easily displayable by local device.

The business integration may include integration as software on local device, integration with portal of an operator, or any other suitable integration. The business model may include subscriber fees, OEM agreement with device manufacturer or operator, or any other suitable revenue source.

Application 2: E-commerce. In some embodiments, the user may be assisted with delayed purchase. By way of illustration, the user may want to track price of an item for some period of time, consult with friends over social network, offer recommendations to other users, read reviews by users or perform additional research on the item of interest prior to acquisition. The user may activate product search from within a website. The server will bring relevant articles, based on search within the website. For each article the server will select only the objects relevant to the user's request and enable preview on the search page. The user may scroll between objects of interest or jump to the article at the object of interest. The navigation between search and the article may be enabled by the website and dedicated anchors inserted into the article. The user may mark the object of interest, add comments and add price tracking statistics and price change alerts. The user may also share the marked content by way of illustration via link to the marked article and anchor over the object of interest. The link may be inserted into social network or blog, sent by e-mail, SMS, IMS or other messaging service. The user may insert several links with easy scrolling between them enabled by dedicated anchors. In some embodiments, other users may add their votes, comments and recommendation on the page marked by the original user. The privacy and security of the process may be enabled by the website via dynamic user and session identifiers, encoding, password protection or other suitable features.

The business integration may include integration with e-commerce site, integration with search engine, integration with entertainment site with referral to e-commerce site, or any other suitable integration. The business model may include subscriber fees, pay-per-impression, pay-per-click, pay-per-action, revenue sharing and other suitable models.

Application 3: Research. In some embodiments the user may be assisted with research activities. The users in a group may execute similar queries. For each search result, the user may see which members of the group got similar search results, how much time they spent analyzing the results, link to report on relevant research activity, user comments any other useful information. In some embodiments the user may request a robot to repeat the search and send alarm if the search results has been changed, or present dedicate symbol for new results during the search report analysis. In some embodiments, the users may annotate several articles and objects within several articles. In some embodiments, the user may link the annotated articles to the research report. In some embodiments, the user may follow changes in the articles within some time frame. In some embodiments user may search other articles referencing the articles of interest. In some embodiments, the search history and research reports may be protected via dedicated security and billing system. In some embodiments, the articles may be protected by security and billing system against forwarding, modifying and other suitable user actions.

In some embodiments, the search results management display may be given as a widget for research on existing data depositories, including by way of illustrations libraries.

The business integration may include integration with enterprise portal, integration with library portal, integration with local device or any other suitable integration. The business model may include subscription fees, report access fees, data source access fees, pay-per-search, group licensing, floating licensing or any other suitable method.

Some embodiments enable look and feel with usability that is non existing in prior art methods, e.g. via the following features:

Usability feature 1: Preview of chosen information, including for example preview of relevant document content w/o the need to open the content. In some embodiments, preview is assisted with navigation options, including navigation between objects of interest found by document scanning algorithms. In some embodiments, the chosen information may be displayed as an overlay over existing services familiar to the user. For example, overlay over search engine results displays objects of interest, overlay over article display comments and annotation. In some embodiments, the preview capabilities may be enabled via transcoding functionality. For example, links transcoding may be performed in order to display embedded images.

Usability feature 2: Simple integration of search, annotation and sharing may be enabled via business logic and single-click or drag-and-drop GUI. In some embodiments the user may pass from object in search results to the object in article via single click. In some embodiments the user may navigate from the article on social media to shopping cart in one click. In some embodiments the user may navigate between several articles of interest, jump between search results and article, activate shopping card and perform other suitable activities in one click.

Usability feature 3: Fast and low bandwidth content preview. In some embodiments, the server-side transcoding, object ranking algorithms and object-scrolling methods on the client side enable bandwidth reduction and preview speed optimization. For example, the styling attributes including by way of illustration color, font, alignment, may be removed prior to activation in target device. For example, the size of images or other embedded objects may be reduced for download and preview optimization.

Usability feature 4: Fast navigation to the content. For example, multiple articles may be downloaded by the server from various content providers in parallel fashion via high-bandwidth interfaces. These articles of choice may be accessible by the user from the preview window, via the servers of the search results management system, w/o additional access to remote servers and content formatting, resulting in superior access to cached articles.

Usability feature 5: History and statistics of previous search and comments of other group members. For example, improving corporate knowledge sharing via display of other users with similar interests, their reports and analysis. In some embodiments, the credentials of the user which first found the information of interest may be added to the information of interest as a digital signature, including credits for the search and search analysis. In some embodiments, monitoring may include dynamic update of the message content as the original article is modified, notification of the user upon changes in the original article, capabilities of reverting to older versions of original document, graphical display of changes in the chosen article or other suitable article monitoring.

Usability feature 6: Project control. The user may choose a project and select with that share the personal searching results and summary reports, which level of encoding may be applied to the results, whether the recipient is authorized to forward the message to other users, integrated billing options per project, group communication settings or other suitable information.

Usability feature 7: Integration of multiple users, multiple devices and multiple service providers. Common search results managements and transcoding capabilities enable integration and aggregation of search statistics, comments and reports from multiple users, with varying display and search capabilities, aggregating search results from different sources into common data repository.

Usability feature 8: Group users. Users may collaborate as a group, so that the users in the group enjoy group-level information and permissions. For example, a group may be formed to research a specific subject, make a decision or generate a report. Groups may be supported by dedicated functions, including group mailing lists, voting procedures, permission hierarchies, billing distribution, group messaging systems or other suitable methods.

Usability feature 9: Integration with browser. In some embodiments, part of the functionality may be integrated with a browser on local device, for example as a plug-in. For example, a device manufactures or software provider may include with the browser some spotting, marking and caching functions. In some embodiments the local device may be synchronized with the server. Local device functionality (1) enables off-line operation on cached or locally stored content, (2) reduces bandwidth and improves speed when accessing cached data (including address book, marked content, visited sites or other suitable information), (3) enables faster rendering and user interface.

It is noted that any one or more of those usability features may be implemented in various embodiments of method 2500, and/or of system 3000.

Details of illustrative embodiments are presented below. It will be appreciated by one expert in the art that similar designs may be used for all suitable structured source documents, using all suitable search or recommendation engine.

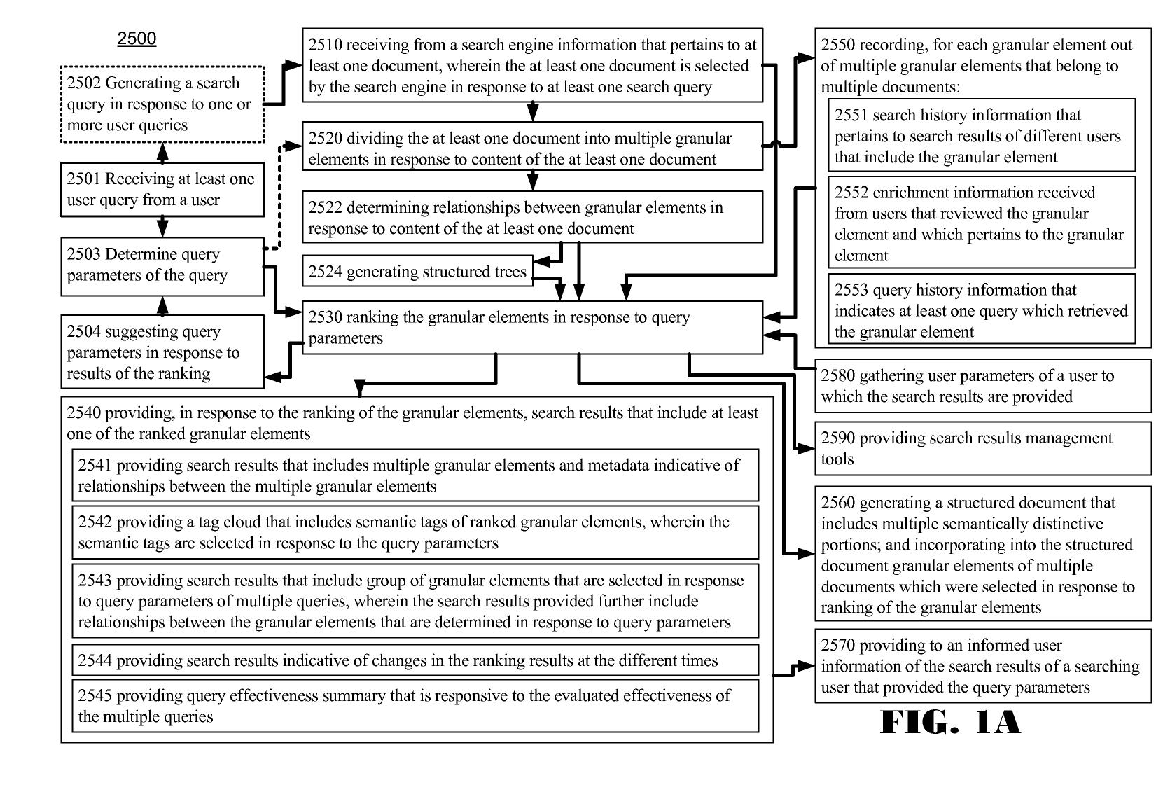

FIG. 1A illustrates method 2500 for search results management, according to an embodiment of the invention.

Method 2500 may start, according to an embodiment of the invention, with stage 2510 of receiving from a search engine information that pertains to at least one document, wherein the at least one document is selected by the search engine in response to at least one search query. Referring to the examples set forth in other drawings, stage 2510 may be carried out by an input interface such as input interface 3100.

It is noted that according to various embodiments of the invention, the at least one query may be provided to the search engine in different ways. For example, the search query may be inserted manually by a user of the search engine, may be provided via a dedicated interface of a system which implements method 2500, may be generated by the system which implements method 2500 in response to user input, may be provided (e.g. by the system which implements method 2500) in scheduled manner or in response to one or more events, and so forth.

According to an embodiment of the invention, method 2500 may include stage 2501 of receiving at least one user query from a user, wherein according to different embodiments of the invention, the query may be generated by the user—with or without the aid of automated assistance—in different ways (e.g. by one or more of the following—free text, tags, selected ranges, multiple selection interface, automated suggestions, random or semi-random options, etc.). The query received from the user may be used for stage 2502 of generating a search query for the search engine (in response to one or more user search queries and possibly also to other factors) and/or as input for other stages, e.g. as exemplified below. Method 2500 may include stage 2503 of determining query parameters in response to one or more queries provided by one or more users. The determined search parameters may influence other stages such as 2520, 2530, and 2540.

It is noted that the documents provided—or referred to—by the search engine (and possibly—by multiple search engines) may be of different kinds—e.g. hyper-text documents, images, music, financial reports, system logs, software usable files, and so forth. Not necessarily all of the documents received in stage 2510 are of the same type.

The information which pertains to the at least one document may include the documents (or portions of which), but this is not necessarily so. For example, the information received may include information of how and/or where to retrieve the documents (or portions thereof) from, information regarding the content of the documents (e.g. tag words, statistics, etc.), descriptive information of the documents, usage information, accuracy estimation, recent updates information, and so forth.

Furthermore, it is noted that stage 2510 may include receiving the information that pertains to documents which were selected by one or more search engines in different occasions, in different times, in response to different queries, and so forth.

Stage 2520 of method 2500 includes dividing the at least one document into multiple granular elements in response to content of the at least one document. It is noted that the dividing may be carried out after the receiving of the information from the search engine, but this is not necessarily so. For example, the information received from the search engine may pertain to documents that have been previously divided into granular elements. The dividing may also include changing an existing division of the document (e.g. by further dividing elements of the documents, by uniting previous granular elements and so forth). Referring to the examples set forth in other drawings, stage 2520 may be carried out by a data structure module such as such as data structure module 3200.

It is noted that the dividing may be carried out automatically, in response to instruction of the user, or in other scenarios (e.g. in response to decision rules, instructions/requests by other entities, etc.)

Granular elements may represent, according to several embodiments of the invention objects, groups of objects or output of any suitable segmentation algorithm. For example, a text portion of the source internet documents may be divided into paragraph-sized granular elements, sentence-sized granular elements, word-sized granular elements, fixed-length strings granular elements, to text which resides within a geometric shape granular elements (regardless of linguistic structure), and so forth. Likewise, a picture granular element may include a picture, a part of a picture, parts of several pictures, and so forth. Also, a single granular element may include more than one type of information (e.g. all the information that resides within a given rectangle).

The dividing of the source internet document into granular document according to different embodiments of the invention is described in more details below, referring to further drawings of the disclosure.

It is noted that the dividing may and may not be responsive to user input, may be carried out in different times in relation to the acquiring (e.g. immediately after, few days later), and may also be an ongoing process, wherein information received in a later time is used for modifying the division of the source internet document into granular elements, modifying which may include changing the division, combining several previous granular elements into one, splitting a single granular elements into several, adding or removing granular elements layers, and so forth.

According to an embodiment of the invention, the dividing of the source internet document into multiple granular elements includes dividing into multiple granular elements according to a structure of the document and/or according to the metadata in (or of) each granular element.

According to an embodiment of the invention, the dividing of the at least one document may be further responsive to at least one of the query parameters.

According to an embodiment of the invention, the dividing of the at least one document may be further responsive to previously gathered user parameters of a user to which the search results are provided in stage 2540. It is noted that, according to such an embodiment of the invention, method 2500 may further include stage 2580 of gathering user parameters of a user to which the search results will be provided. It is noted that such user parameters may be related to previous searches and/or preferences (e.g. what did the user query, which results did the user prefer), and may be unrelated (e.g. demographic parameters, internet connection speed, etc.).

Various implementations of dividing of documents into granular elements as well as usage of such divisions are discussed in U.S. patent application Ser. No. 12/416,947, entitled “Systems, Methods and Computer Program Products for Content Management” by the same inventor, filed Apr. 2, 2009, which is incorporated herein in its entirety. It is however noted that the implementation of granular elements and the usage of which is not limited to those introduced in the aforementioned disclosure.

It is noted that some or all of the granular elements may contain information regarding between different granular elements. For example, one granular element may contain information pointing to a parent granular element, to a sibling granular element, and/or other one or more granular element. Information regarding relationships between granular elements may also be stored outside of granular elements. According to an embodiment of the invention, method 2500 may include stage 2522 of determining (usually prior to stage 530 of ranking) relationships between granular elements in response to content of the at least one document. The determined relationships may be used for various uses, such as affecting the ranking in stage 2530, affecting the providing in stage 2540, affecting the recording in stage 5250, affecting the generating of the structured document in stage 2560, and/or affecting other processes, such as those discussed in the aforementioned U.S. applications that are incorporated by reference.

Referring to the examples set forth in other drawings, stage 2522 may be carried out by a data structure module such as data structure module 3200.

It is noted that according to an embodiment of the invention, method 2500 may include stage 2524 of generating structured trees wherein each of the structured trees includes multiple granular elements, and wherein the structure of each of the structured trees is responsive to relationships between the granular elements of the structured tree. It is noted that according to some embodiments of the invention, some or all of the activities described below (e.g. of stages 2530, 2540, 2550, etc.) may be implemented for such structured trees instead (or in addition) to operations on granular elements.

Generating and using of structured documents may be implemented as disclosed in U.S. patent application Ser. No. 12/511,747, filed Jul. 29, 2009, entitled “System, Methods and Applications for Structured Document Indexing”. However, it is noted that other structured documents and techniques of generating and implementing those may be used.

According to various embodiments of the invention, systems, methods and computer program products for multi-resolution structured document representation that enables enhanced contextual search, marking, storage, and user notification, are disclosed. A structured document of interest may be segmented into sections, which in turn may be segmented into fragments via dedicated segmentation algorithms. The sections and fragments of the structured document may be associated with metadata, including overlay layers, search indices, notification events, cross-reference processing, user data and document history. The duplicate sections may be removed based on reference count, resulting in efficient storage. Search-within-search application enables search of fragments and sections inside the documents of interest. Contextual marking application enables marking, tagging and annotation of the fragments of interest. Notification application enables user notification upon changes in section of interest.

For example, according to an embodiment of the invention, method 2500 may include the following stages, which follow stage 2520: (a) analyzing the multiple granular elements of a source document (possibly of multiple source documents) to generate multiple low level sub-trees, wherein each of the low level sub-trees includes at least one of the multiple objects; (b) generating multiple mid level sub-trees, wherein each of the mid level sub-trees includes link to at least one of the low level sub-trees; (c) generating a top level sub-tree that includes multiple section links, wherein each of the section links links to one of the mid level sub-trees; (d) creating metadata descriptive of at least one of the sub-trees generated, wherein the metadata includes data which is not included in the source document; and (e) generating a structured document that includes the top level sub-tree, at least some of the mid level sub-trees and at least some of the low level sub-trees, and the metadata.

Stage 2530 of method 2500 includes ranking the granular elements in response to query parameters. Referring to the examples set forth in other drawings, stage 2530 may be carried out by a ranking module such as ranking module 3300.

It is noted that the query parameters may relate to the search query used by the search engine in stage 2510, but this is not necessarily so, as the one or more queries used for the ranking may be distinct (partially or entirely) from the queries of the search engines. By way of example, one or more user may use multiple search queries for retrieving information about a large number of documents from the search engine, and than used other refined queries for ranking the documents, or some or all of the granular elements of which.

It should be noted that the ranking of stage 2530 is ranking of granular elements, and not of the entire document (even though such ranking may be used for ranking of documents—e.g. by summing the ranking of the distinct granular elements). In such a way various types of granular elements may be ranked—from one or more documents. Also—the ranking may be of granular elements of various resolution—possibly according to selection of a user.

For example, the ranking may include ranking different paragraphs within a document in response to various query words of the user, may find similar images in various documents, may find records of people of given demographic parameters in a multiple historical censuses, and so forth.

According to an embodiment of the invention, the ranking may be responsive to relationships between different granular elements, wherein the method may further include determining, prior to the ranking (e.g. in stage 2522), relationships between granular elements in response to content of the at least one document. It is however noted that relationships between granular elements may also be suggested by the search engine, by the user or other users/searchers, by external systems/sources, and so forth.

According to an embodiment of the invention in which generating of structured trees is implemented (e.g. wherein each of the structured trees comprises multiple granular elements, and wherein the structure of each of the structured trees is responsive to relationships between the granular elements of the structured tree), the ranking may include ranking the structured trees in response to the ranking of the granular elements of each of the structure trees and in response to the relationships between those granular elements; wherein the providing of stage 2540 may include providing search results that include at least one ranked structured tree.

According to an embodiment of the invention, method 2500 may further include stage 2504 of suggesting query parameters in response to results of the ranking. This may be associated with stage 2553 and/or stage 2545, but not necessarily so.

According to an embodiment of the invention, the ranking may include ranking the granular elements in response to query parameters of multiple queries.

Method 2500 further includes stage 2540 of providing, in response to the ranking of the granular elements, search results that include at least one of the ranked granular elements, or at least information pertaining to which. Referring to the examples set forth in other drawings, stage 2540 may be carried out by an output interface such as output interface 3500.

It is noted that the search results may be provided in various ways—e.g. in a list format, as a graphical representation, as a formatted graph, as a hyper-text document, and so forth. The providing of the search results may be in itself responsive to the search parameters (e.g. queried words may be highlighted within paragraphs, the graphical interface may be divided to different areas reprehensive of different search ranges defined by the user, and so forth).

The search results may be provided, by way of example, as an automatically generated report that includes listing of one or more executed queries as well as the selected granular elements (which were selected out of the articles or other documents chosen by the search engine), wherein that report may enable the further use of this information. Such further use may be enabled by an interface that is included within the report itself (e.g. buttons or links within an HTML report), and/or by a dedicated interface (e.g. a toolbar installed within an internet browser, a dedicated software/hardware, etc).

Such a report provides users with concentrated knowledge depository, which can be used for various means. The provided report (or other forms in which search results can be provided) may be implemented for different utilizations, such as (though not limited to) collaborating between users, implementing social functions on it, using report templates, trading reports, writing documents with one or more reports serving as references, and so forth. Some such implementations are discussed in more details below.

It is noted that wherever search results are discussed in this application, different forms and scopes of search results may be implemented, among which are search results reports as discussed above.

It should be noted that the various granular elements provided in the search results (e.g. in the report) may be provided in an independent way (e.g. as stand-alone entries, ranked or not), and may be provided in an at least partially dependent way, wherein the interdependency may be direct (between one granular element to another) and may be indirect (from an external object—e.g. post-query preferences such as “prioritize granular elements reviewed by known peer reviewer).

Generally, it is noted that according to an embodiment of the invention, all of the multiple granular elements of the search results provided may belong to a single document, wherein the receiving, the ranking and the providing may be triggered by a single query of the user. However, as aforementioned, this is not necessarily so. It is nevertheless noted that according to such an embodiment of the invention, the user is not required to make another selection of whether to refine the analysis of the retrieved documents, whether to perform a search of granular elements within the search results, and so forth. Also, this may also be applied for analyzing granular elements retrieved from multiple documents, and possibly also for documents retrieved in response to various queries to the search engine (which may possibly be the offspring of a single user-generated query).

According to an embodiment of the invention, method 2500 may further include providing a search results report that includes the search results and at least one calculated key indicator. Such key indicator may be, according to an embodiment of the invention, selected from a group consisting of semantic information (e.g. tag clouds, emotion evaluation information, vertical information, etc), significancy value (evaluating the significance of the information provided in the search results, e.g. based on number of included granular elements, based on the number of queries and/or query parameters required to produce the search results report, the number of people who collaborated on the report, reader's responses, and so forth), and size (e.g. number of atomic elements, number of words, depth of the structure tree of the search report, if implemented, and so forth). It is however noted that other key indicators may be calculated and used in other embodiments of the invention. According to an embodiment of the invention, one or more key indicators may be calculated only for a portion of the search results.

According to an embodiment of the invention, method 2500 may further include providing additional search results (to this user or to another user, using the same set of query parameters or another set), wherein the additional search results are responsive to at least one of the key indicators provided for preceding search results.

According to an embodiment of the invention, method 2500 may include modifying, after the providing of the search results, a search results report. It is noted that the modifying may be carried out in different ways—e.g. via mutation, by adding or removing granular elements; by merging that includes incorporating granular elements from other reports, and so on. It is noted that such modifying of the search results may also be carried out before the providing of the search results to the user or to an external system or module. It is further noted that such modification may be responsive to user input, and may be automatic.

According to an embodiment of the invention, the modifying of the search results report is responsive to at least one of the key indicators calculated for at least one other report. For example, since each report may be associated with value, a human computation algorithm may be achieved, which will generate progressively better reports.

According to an embodiment of the invention, method 2500 may further include providing a search results report that includes search results constructed in response to a first template (e.g. an article structure, divided into background general material, specific new results, and opposing views), wherein the constructing is preceded by creating the first template by modifying a second template used for the construction of another search report. For example, the first template may be copied or partially copied from another report. Some modification may include using a high-level tree structure instead of low-level tree structure which was implemented in the second template.

According to an embodiment of the invention, method 2500 may further include determining billing value for the purchasing of the second template. According to an embodiment of the invention, templates may be stored and traded on their own. According to an embodiment of the invention, per template leaf progress report may be recorded.

According to an embodiment of the invention, the providing may include stage 2541 of providing search results that include multiple granular elements and metadata indicative of relationships between the multiple granular elements. The metadata may be indicative of relationships that were determined prior to the ranking (e.g. those of stage 5250), or following the ranking—and possibly in response to which. For example, after the granular elements that will be included in the search results were selected, the method may include determining relationship between those selected ranked granular element (e.g. in response to content of which, to their connection to different documents, and so forth).

It is noted that method 2500 may also include recording, for each granular element out of multiple granular elements that belong to multiple documents, various kinds of information (denoted 2550). Referring to the examples set forth in other drawings, the recording may be carried out by a database manager such as database manager 3600.

The recorded information may be used for different uses, such as for ranking granular elements according to such recorded information. The recorded information may also be used for dividing of documents into granular elements (or for modifying an existing division), for generation of metadata pertaining to documents, users, and granular elements, for determining what and how to provided as search results, and so forth.

For example, according to an embodiment of the invention, method 2500 may further include stage 2551 of recording, for each granular element out of multiple granular elements that belong to multiple documents, search history information that pertains to search results of different users that included the granular element (i.e. when the same—or similar, or related—granular element was included in different sets of search results that were provided to different users). According to such an embodiment of the invention, the ranking may be further responsive to the search history information of multiple granular elements. It is noted that other stages (e.g. 2520, generating search results, 2540, 2502, etc.) may also be response to the search history information of one or more granular elements.

Recording of such search history information may search social implementations such as collaboration. For example, multiple researchers may contribute to the generation of a corpus of documents by searching various search results, and then evaluate granular elements, wherein one user may wish to receive results in response to the evaluation of other users.

According to an embodiment of the invention, method 2500 may further include recording, for each granular element out of multiple granular elements that belong to multiple documents, enrichment information received from users that reviewed the granular element and which pertains to the granular element (denoted 2552); wherein the ranking may include ranking the granular elements in response to enrichment information of multiple granular elements. The reviewing by the other users may include evaluating, adding comments, ranking, validating, and so forth. The reviewing may be an intended reviewing (e.g. commenting) but may also be derived (e.g. the amount of time each granular element was viewed in a browser of another user).

It is noted that the enrichment information received for one or more granular element (which may also be referred to as associated information) may be received from another user (e.g. a web user, an intranet user, etc.) may be associated with a referenced granular element that is selected in response to user selection of that other user. The enrichment information may be used, by way of example, for generating a second internet document that includes the referenced granular element, other granular elements, and the enrichment information, wherein the generating is responsive may be responsive to metadata of at least one granular element.

According to an embodiment of the invention, method 2500 may further include stage 2553 of recording, for each granular element out of multiple granular elements that belong to multiple documents, query history information that indicates at least one query which retrieved the granular element; wherein method 2500 may further include providing information which is determined in response to the query history information of multiple granular elements. This may be used, for example, in order to assist users generate more efficient queries.

According to an embodiment of the invention, method 2500 may further include creating semantic tags for multiple granular elements, as well as stage 2542 (which may be a part of the providing of the search results) of providing a tag cloud that includes semantic tags of ranked granular elements, wherein the semantic tags are selected in response to the query parameters. That is, the tag cloud may include the tags which are only relevant to the granular elements selected from the entire granular elements of the document indicated by the search engine (in response to one or more search queries to the search engines, as well as to query parameters of one or more queries).

According to an embodiment of the invention, method 2500 includes stage 2543 of providing search results that include group of granular elements that are selected in response to query parameters of multiple queries, wherein the search results provided further include relationships between the granular elements, wherein those relationships are determined in response to query parameters. For example, in the search result a first granular element may be selected as a representative granular element of several granular elements that are provided as variants.

According to an embodiment of the invention, method 2500 may further include ranking of granular elements at different times using the same query parameters (either an identical set of query parameters, or somewhat different set that includes at least one same query parameter) and providing search results (denoted 2544) indicative of changes in the ranking results at the different times. This may, by way of example, enable a user to search only for the paragraphs or entries which have been modified in a set of documents, to be notified about new media items which are included in html documents, and so forth.

It is noted that the method may further include evaluating effectiveness of multiple queries—usually in the granular element level—and providing query effectiveness summary (denoted sage 2545) that is responsive to the evaluated effectiveness of the multiple queries. For example, the query effectiveness summary may indicate that many queries by the user resulted in substantially the same group of granular element, that the results of a single query were reviewed for a longer time or in more depth, and that the granular elements provided in a search result for queries having a first tag used for search resulted with granular elements which have more significant relationships between them.

According to an embodiment of the invention, method 2500 may further include suggesting query parameters in response to results of the ranking (which may depend on the result of stage 2545, but not necessarily so).

According to an embodiment of the invention, method 2500 may include finding different documents that include multiple similar granular elements (either identical or not), and providing search results indicative of the found documents. This may be used for various utilizations, such as finding of copyright infringement, analyzing the flow and/or development of knowledge in a community, and so forth.

According to an embodiment of the invention, method 2500 may include stage 2570 of providing to an informed user information of the search results of a searching user that provided the query parameters. This may be used for various utilizations such as supervision, collaboration, for legal reasons, and so forth.

According to an embodiment of the invention, method 2500 may include stage 2560 of generating a structured document that includes multiple semantically distinctive portions; and incorporating into the structured document granular elements of multiple documents which were selected in response to ranking of the granular elements. For example, the general structure of an article may be generated (heading, background, new discoveries, discussion, references, etc.), and different granular elements may be automatically inserted into the proper sections of the structured article.

According to an embodiment of the invention, the building of the structures may be automatic, may be at least partly in response to user structure information, may be from another document, may be a result of semantic analysis of one or more documents, and so forth.

According to an embodiment of the invention, method 2500 may further include recording billing information for at least one of the above disclosed operations/stages, and billing at least one user for that action. This may also enable selling of generated documents (e.g. of stage 2560) to other users, and possibly using selected granular elements/tags etc. for the promoting of such selling.

Method 2500 may further include additional stages of utilizing the search results, such as (though not limited to) analyzing at least a portion of the search results, printing at least a portion of the search results, writing at least a portion of the search results to a tangible media (e.g. an optical disc, a magnetic media, stone, projector, etc.), converting at least a portion of the search results to an electromagnetic and/or acoustic signal, and transmitting the signal over a wired connection or a wireless connection, a network connection, and so forth.

According to an embodiment of the invention, method 2500 may further include stage 2590 of providing search results management tools, which enables a user (the term user may refer to a human or to a system) to utilize and/or manipulate the search results in various ways. It is noted that such search results management tools may be provided, according to an embodiment of the invention, with the search results (e.g. within the search reports) or externally to it (e.g. using a dedicated interface/toolbar/software/hardware, etc.).

According to an embodiment of the invention, the providing of the search results management tools may include providing of tools for affecting (by the user) the ranking of at least one granular element. The affecting of the ranking may result in modifying the provided search result, and may affect future ranking of granular elements.

According to an embodiment of the invention, the providing of the search results management tools may include providing of tools for modifying query parameters. The modifying of the query parameters may result in modifying the provided search result, and may affect future search results. It is noted that the query parameters modified may applied to other users—e.g. to commenting or ranking of other users, to search results of other users, to preferences of other users, etc.

According to an embodiment of the invention, the providing of the search results management tools may include providing of tools for commenting on one or more granular elements of the search results, and/or on a group of granular elements (either previously interconnected, or grouped by the user). Such commenting may also be used, for example, for user retrieval of granular elements, for reviewing to be read by other users, etc.

According to an embodiment of the invention, the providing of the search results management tools may include providing of tools for requesting the generation of a semantic tag cloud (e.g. which results in stage 2542), or affecting a tag cloud already provided (e.g. adding a query to the queries to which the tag cloud refers, etc.).

According to an embodiment of the invention, the providing of the search results management tools may include providing of tools for saving the search results (as a unit, or granular elements or groups thereof).

According to an embodiment of the invention, the providing of the search results management tools may include providing of tools for selecting one or more granular elements for another action (e.g. commenting, sending to another user, adding to a document, etc.).

According to an embodiment of the invention, the providing of the search results management tools may include providing of tools for analyzing the source documents from which one or more of the granular elements of the search results were provided. Such analysis may include, for example, comparing those documents, finding common traits, etc.

According to an embodiment of the invention, the providing of the search results management tools may include providing of tools for selecting one or more of the documents indicated by the search engine (e.g. by selecting granular elements associated with which), and further operating on the original documents—e.g. saving at least one of the documents, operating automatic, semi-automatic or manual reconstruction of the at least one document into a structured tree, and using that structured tree for editing the document/creating a new document with similar structured tree, and so forth.

According to an embodiment of the invention, the providing of the search results management tools may include providing of tools for providing feedback as to the effectiveness of the results provided (e.g. referring to the results in general, referring to various granular elements in general, etc.)

According to an embodiment of the invention, the providing of the search results management tools may include providing of tools for finding further search results which are related to one or more granular elements retrieved (e.g. a “more like this” function). It is noted that such an action may require providing new query to the search engine, but this is not necessarily so. The additional search results may be also be provided, by way of example, from previously indexed granular elements.

According to an embodiment of the invention, the providing of the search results management tools may include providing of tools for acquiring a document or a portion thereof (e.g. paying for a document).

According to an embodiment of the invention, the providing of the search results management tools may include providing of tools for comparing the search results to other search results which were generated (either actually or by simulation) using similar query parameters at previous times (e.g. a day ago, a week ago, in predetermined intervals, at a user specified time, and so forth).

According to an embodiment of the invention, the providing of the search results management tools may include providing of tools for adapting the search results (and/or relevant documents) to a target device (e.g. handheld device).

According to an embodiment of the invention, the providing of the search results management tools may include providing of tools for suggesting granular elements and/or documents to other users.

According to an embodiment of the invention, the providing of the search results management tools may include providing of tools for selecting between granular elements and/or documented suggested (e.g. by a system that implements method 2500). It is noted that according to an embodiment of the invention, method 2500 may further include a stage of suggesting to the user at least one other granular element and/or document—wherein such suggestion may be responsive, by way of example only to one or more of the following: the search results, the originating document from which the granular elements were suggested, past preferences of the user, commenting by other users, reviewing by other users, external parameters such as rate of exchange of a given currency, time of the day, and so forth.

According to an embodiment of the invention, the providing of the search results management tools may include providing of tools for reviewing/commenting on a granular element, and sending to another person entity the comments/reviewing (and possibly also the commented granular element and/or some or all of its originating document).

According to an embodiment of the invention, the providing of the search results management tools may include providing of tools for creating a structured tree (e.g. in response to a structure derive from another document, in response to a preferred template, and so forth), and for inserting some or all of the granular elements of the search results (as well as potentially other granular elements, e.g. previously selected) into their proper locations within the structure tree.

According to an embodiment of the invention, the providing of the search results management tools may include providing of tools for collaborating with other users, wherein the collaborating may include, by way of example, sharing the history, the search results, a common repository of selected granular elements and/or documents, and so forth. The tools for collaborating may also include tools for sharing the work, e.g. for delegating tasks. It is noted that previous stages such as stage 2530 may be responsive to information (e.g. query parameters) received from multiple users—e.g. of a collaboration group.

According to an embodiment of the invention, the providing of the search results management tools may include providing of tools for generating alerts for one or more searches. Those searches alerts may be responsive not only to the query of the user, but also to other parameters such as such as results history of that user, preferences of a group of users, and so forth. Method 2500 may further include reviewing multiple documents and/or granular elements in response to search alerts of the user, and providing responsive search results.

According to an embodiment of the invention, the providing of the search results management tools may include providing of tools for selecting between different tags (e.g. type of product to look for, range of prices, websites to search in, relevant market size, etc.), some of which may be provided by the system that implements method 2500 according to the search results (and/or to previously available information regarding the user).

According to an embodiment of the invention, the providing of the search results management tools may include providing of tools for defining alerts that pertain to one or more specific documents, for which update information may be desired, wherein the method may further include providing update information that pertain to the one or more specific document, in response to the defined alerts. For example, the user may define that if a certain blog is updated with information that corresponds to New York Times article of the same day, this information should be saved and alerted.

According to an embodiment of the invention, the providing of the search results management tools may include providing of tools for suggesting the search results to external search engines (for example, if the user is capable of making efficient data mining, it may benefit by having his website highly ranked by external search engines).

It is further noted that additional tools may be provided, which are not necessarily related to the search results.

For example, a user may transmit a user-made document (which may be generated in response or using granular elements of the search results, but not necessarily so), so that portions of which may be provided as search results (either as documents available to the search engine, or as part of the search results that are provided additionally). As billing may already be implemented in the method (even though not necessarily so), a user main gain profit (e.g. money, points, ranking, reputation, etc.) when his user-made document is provided as a search results or is retrieved by another user.

It is noted that since method 2500 may include collecting information pertaining to many users (e.g. in stages 2550, 2580), a stage of promoting and/or offering the user-made document to other user that may be interested in such document.

It is noted that method 2500 may further include logging any of the above operations, and any of the results of such operations.

It is noted that the providing of the search results that include, according to an embodiment of the invention, only or substantially the ranked granular elements—and not of the entire documents—enables much faster providing of the search results, and saves channel bandwidth.

According to an embodiment of the invention, some or all of the stages of method 2500 may be reiterated. According to an embodiment of the invention, in a second reiteration the receiving of the information that pertains to the at least one document includes receiving information from a search results that were provided in a first iteration (either for the same user or to another user, possibly after processing by the user). According to an embodiment of the invention, a user my upload existing report to be used by the system.

A computer readable medium (or media) is disclosed, the computer readable medium having a computer readable code embodied therein for data managing, the computer readable code including instructions for: (a) receiving from a search engine information that pertains to at least one document, wherein the at least one document is selected by the search engine in response to at least one search query; (b) dividing the at least one document into multiple granular elements in response to content of the at least one document; (c) ranking the granular elements in response to query parameters, and (d) providing, in response to the ranking of the granular elements, search results that include at least one of the ranked granular elements. It is noted that various embodiments of the computer readable code includes instructions for the different stages of method 2500 according to its various embodiments. Also, the computer readable medium may conveniently be read by one or more components of system 3000, and the different portions may conveniently be executed by one or more of the at least one hardware processors or components of system 3000 (e.g. 3100, 3200, 3300, 3400, 3500, 3600).

FIG. 1B illustrates system 3000, according to an embodiment of the invention. It is noted that various embodiments of system 3000 may implement the various embodiments of method 2500 (even if not explicitly elaborated), and vice versa.

System 3000 includes input interface 3100 that is configured to receive from a search engine (denoted 2800) information that pertains to at least one document, wherein the at least one document is selected by search engine 2800 in response to at least one search query. It is noted that according to various embodiments of the invention, input interface 3100 may be configured to receive an electromagnetic and/or acoustic signal (or other types of signals that are known in the art), and to transduce the received signal into an electronic signal that is processable by other components of system 3000 like components 3200 and 3300 discussed below. It is noted that according to some embodiments of the invention, input interface 3100 may also be (or include) a microphone, a camera, and so forth.

System 3000 further includes data structure module 3200, connected to input interface 3100, which is configured to divide the at least one document into multiple granular elements in response to content of the at least one document, as well as ranking module 3300 which is also connected to input interface 3100, and which is configured to the granular elements in response to query parameters. It is noted that data structure module 3200 and ranking module 3300 may be implemented on a single processor/chip, but this is not necessarily so. Each of components 3200 and 3300 may include hardware components, software components, firmware components, and any combination of which.

System 3000 also includes output interface 3500 that is connected to ranking module 3300—either directly or indirectly (e.g. by analyzing module 3400). Output interface 3500 is configured to provide, in response to the ranking of the granular elements, search results that include at least one of the ranked granular elements (i.e. either the form of providing is responsive to the ranking of the granular elements, and/or the search results are generated in response to the ranking of the granular elements).

It is noted that according to various embodiments of the invention, output interface 3500 may be configured to receive an electronic signal processable by other components of system 3000 like components 3200, 3300, and 3400, and to transducer that signal into an electromagnetic and/or acoustic signal (or other types of signals that are known in the art). It is noted that according to some embodiments of the invention, input interface 3100 may also be (or include) a microphone, a camera, and so forth.

In some embodiments of the invention, output interface 3500 may include a printer for printing at least a portion of the search results, a media writer for writing at least a portion of the search results to a tangible media (e.g. an optical disc, a magnetic media, stone, projector, etc.), a display and/or a speaker configured for converting at least a portion of the search results to an electromagnetic and/or acoustic signal, a communication interface for transmitting the signal over a wired connection or a wireless connection, a network connection, and so forth.

System 3000 may include analyzing module 3400 which is configured to receive the ranking of the granular elements from ranking module 3300, to receive the granular elements (or information pertaining to which) from ranking module 3300 of from data structure module 3200, to analyze the ranking of the granular elements so as to provide the search results, and to provide the search results to output interface 3500. It is noted that analyzing module may be implemented on the same processor/chip as at least one of 3200, 3300, but this is not necessarily so.

According to an embodiment of the invention, data structure module 3200 is further configured to divide the at least one document further in response to at least one of the query parameters.

According to an embodiment of the invention, data structure module 3200 is further configured to divide the at least one document further in response to previously gathered user parameters of a user to which the search results are provided.

According to an embodiment of the invention, all of the multiple granular elements of the search results provided belong to a single document, wherein the receiving, the ranking and the providing are triggered by a single query of the user.

According to an embodiment of the invention, output interface 3500 and/or analyzing module 3400 is further configured to provide search results that include multiple granular elements and metadata indicative of relationships between the multiple granular elements.

According to an embodiment of the invention, ranking module 3300 is configured to rank the granular elements further in response to relationships between different granular elements, wherein at least one component of system 3000 (e.g. data structure module 3200) is further configured to determine relationships between granular elements in response to content of the at least one document.

According to an embodiment of the invention, system 3000 further includes database manager 3600 which is configured to store data pertaining to granular elements, for use by other processing module (e.g. 3200, 3300, and 3400). Conveniently, database manager 3600 includes (or is connected to) at least one tangible memory media, that is adapted to store tangible representation of electrical signals (e.g. in magnetic form, in optical form, and so forth).

According to an embodiment of the invention, database manager 3600 may be configured for recording, for each granular element out of multiple granular elements that belong to multiple documents, search history information that pertains to search results of different users that included the granular element; wherein ranking module 3300 is further configured for ranking further in response to the search history information of multiple granular elements.

According to an embodiment of the invention, database manager 3600 may be configured for recording, for each granular element out of multiple granular elements that belong to multiple documents, enrichment information received from users that reviewed the granular element and which pertains to the granular element; wherein ranking module 3300 is further configured for ranking further in response to enrichment information of multiple granular elements.

According to an embodiment of the invention, database manager 3600 may be configured for recording, for each granular element out of multiple granular elements that belong to multiple documents, query history information that indicates at least one query which retrieved the granular element; wherein at least one of analyzing module 3400 and of output interface 3500 is configured to provide information which is determined in response to the query history information of multiple granular elements.

According to an embodiment of the invention, a processor of system 3000 (e.g. analyzer module 3400, and/or data structure module 3200, or a processing module not illustrated) is configured to create semantic tags for multiple granular elements, wherein at least one of analyzing module 3400 and of output interface 3500 is configured to provide a tag cloud that includes semantic tags of ranked granular elements, wherein the semantic tags are selected in response to the query parameters.

According to an embodiment of the invention, at least one of analyzing module 3400 and of output interface 3500 is configured to providing search results that include group of granular elements that are selected in response to query parameters of multiple queries, wherein the search results provided further include relationships between the granular elements that are determined in response to query parameters.

According to an embodiment of the invention, at least one processor of system 3000 (e.g. analyzer module 3400) is configured to generate a structured document that includes multiple semantically distinctive portions; and to incorporate into the structured document granular elements of multiple documents which were selected in response to ranking of the granular elements.

According to an embodiment of the invention, at least one processor of system 3000 (e.g. analyzer module 3400) is configured to evaluate effectiveness of multiple queries, wherein at least one of analyzing module 3400 and of output interface 3500 is configured to provide query effectiveness summary that is responsive to the evaluated effectiveness of the multiple queries.

According to an embodiment of the invention, ranking module 3300 is further configured to rank granular elements at different times using the same query parameters, wherein at least one processor of system 3000 is configured to provide search results indicative of changes in the ranking results at the different times.

According to an embodiment of the invention, at least one processor of system 3000 is configured to suggest query parameters in response to results of the ranking.

According to an embodiment of the invention, at least one processor of system 3000 is configured to find different documents that include multiple similar granular elements, and to provide search results indicative of the found documents.

According to an embodiment of the invention, at least one component of system 3000 (e.g. 3400, 3500) is configured to provide to an informed user information of the search results of a searching user that provided the query parameters.

According to an embodiment of the invention, at least one processor of system 3000 (e.g. data structure module 3200) is further configured for generating structured trees wherein each of the structured trees includes multiple granular elements, and wherein the structure of each of the structured trees is responsive to relationships between the granular elements of the structured tree; wherein tanking module 3300 is further configured to rank the structured trees in response to the ranking of the granular elements of each of the structure trees and in response to the relationships between those granular elements; wherein at least one of 3400 and 3500 is configured to provide search results that include at least one ranked structured tree.

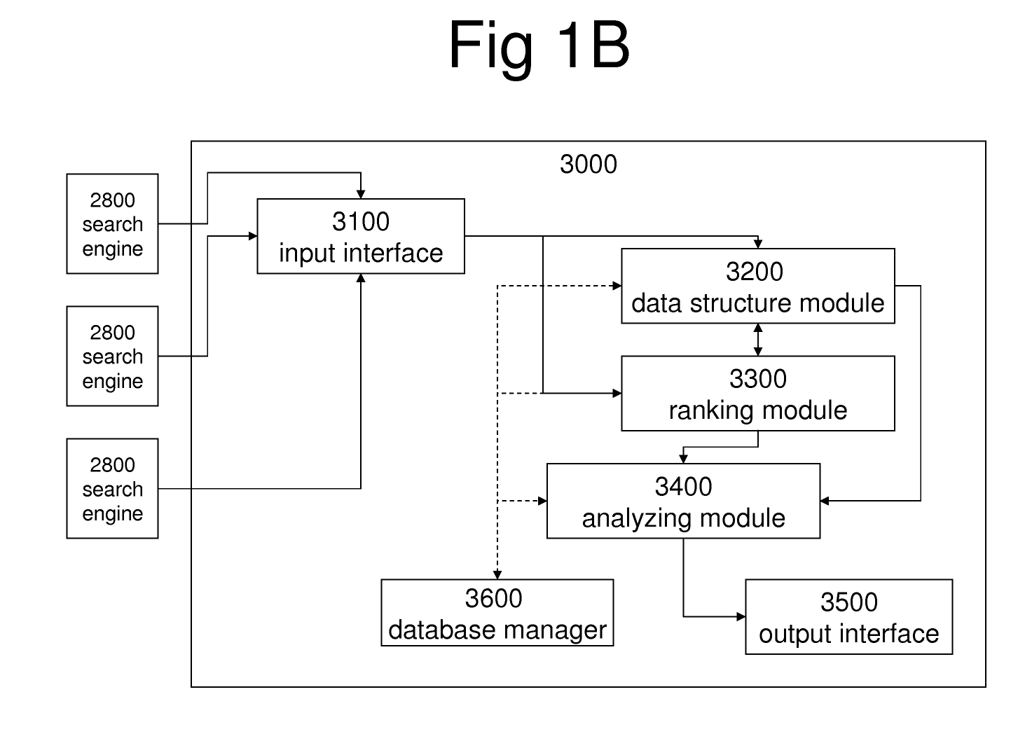

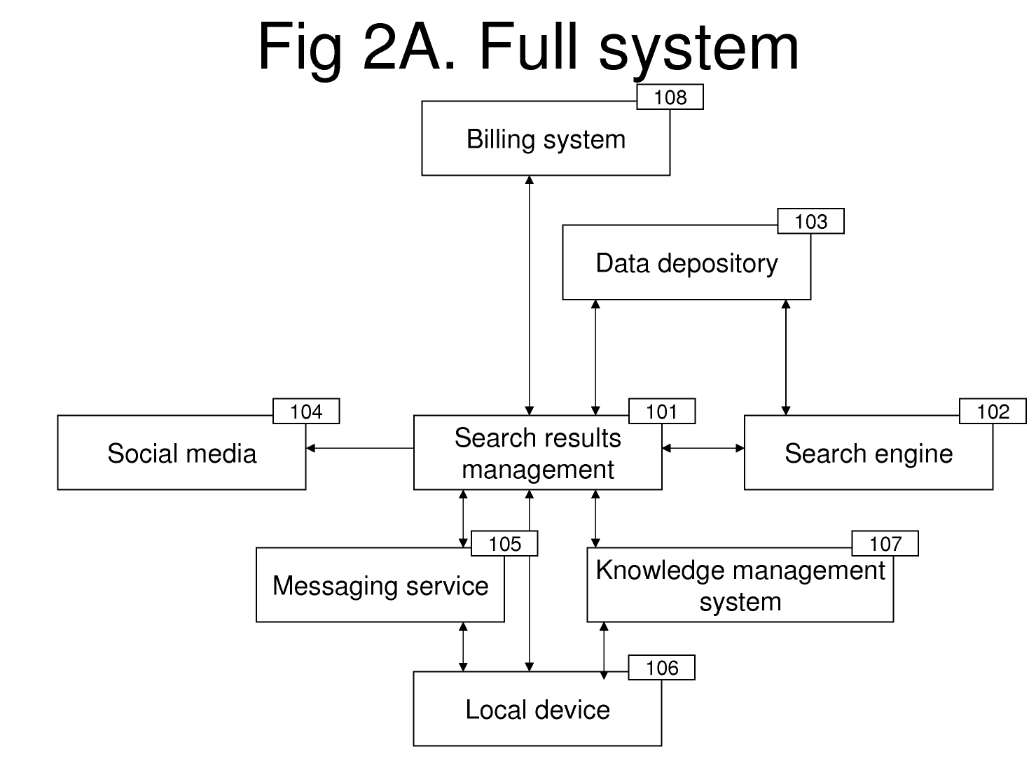

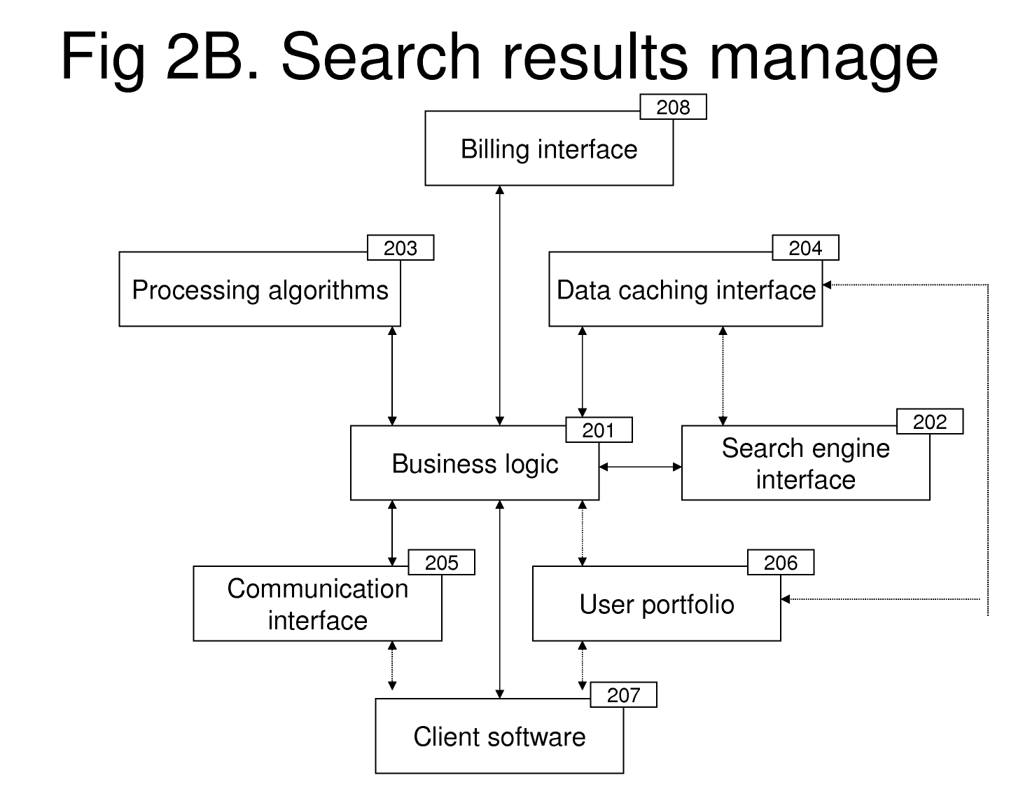

FIG. 2A presents an embodiment of integration of a search results management system, according to an embodiment of the invention. It is noted that various components of the system of FIG. 2A may be incorporated into system 3000, where applicable, even if not explicitly elaborated. Also, functionalities of the different components of the system of FIG. 2A may be implemented as stages of method 2500.

Search results manager 101: Search results management, may be integrated with other systems via interfaces discussed on FIG. 2B, enabling integration between other systems and superior usability.

Search engine 102 (according to an embodiment of the invention it is interchangeable with search engine 2800): Search engine, including web search, desktop search, enterprise portal search, website-specific search, contact search, map search, database search or any other suitable search. The search engines receive a query and supply a formatted collection of articles that are relevant to the query. In some embodiments, search engines supply ranking of the relevant articles, preview of the relevant articles, suggestions and auto-completion to the query or other suitable services.

Data depository 103 (according to an embodiment of the invention, it is interchangeable with database manager 3600): Data depository, including relational database, XML database, file storage, distributed storage systems, distributed computer networks, content delivery systems, content providers or other suitable data depository. The data depository systems may support data upload, data download, data removal, data properties query and other suitable methods. The data depositories may provide input data for search engines 102, caching capabilities for search results management 101 or other suitable services. In some embodiments, the data stored on data depository is formatted specifically for interfacing search engines 102, including indexing, ZIP compression, URL cloacking, or other suitable methods.

Social media system 104: Social media, including social networks, collaborative browsing platforms, virtual reality platforms, blogs, video conferencing system or other suitable communication systems. Via social media third party users may view the output of search results management, comment on the results, aggregate additional content or perform other suitable operations.

Messaging service manager 105: Messaging service, including, instant messaging platforms, e-mail systems, blogs, mobile messaging systems, video conferencing system or other suitable communication systems. Via messaging services the user may receive automated events/alarms, collaborate with other users or perform other suitable activities.

Local device 106 (according to an embodiment of the invention, this may be the device used by the user of method 2500 and/or of system 3000): Local device, including personal computer, mobile device, IPTV or any other suitable device with data entry, display capabilities and network connectivity with messaging services 105 and search results management knowledge management system 107. Via local devices the users may communicate with search results management system, including activating queries, viewing query results, viewing articles, marking articles or other suitable activities.

Knowledge management system 107: Knowledge management system, including enterprise knowledge management systems, web analytics, statistical software, data mining systems, human analysts or other suitable services. Via knowledge management system the collected information may be analyzed, trends detected, key indicators monitored and other suitable activity performed.

Billing system 108: Billing system, including billing rates, user authorization, payment programs, subscription fees, shopping card, credit card, prepaid shopping, affiliation programs, reference fees or other suitable financial services. Via billing system users may pay for the services and the service providers are paid for the services.

FIG. 2B presents an embodiment of the design of proposed search results management search results manager 101. It is noted that various components of the system of FIG. 2B may be incorporated into system 3000, where applicable, even if not explicitly elaborated. Also, functionalities of the different components of the system of FIG. 2B may be implemented as stages of method 2500.

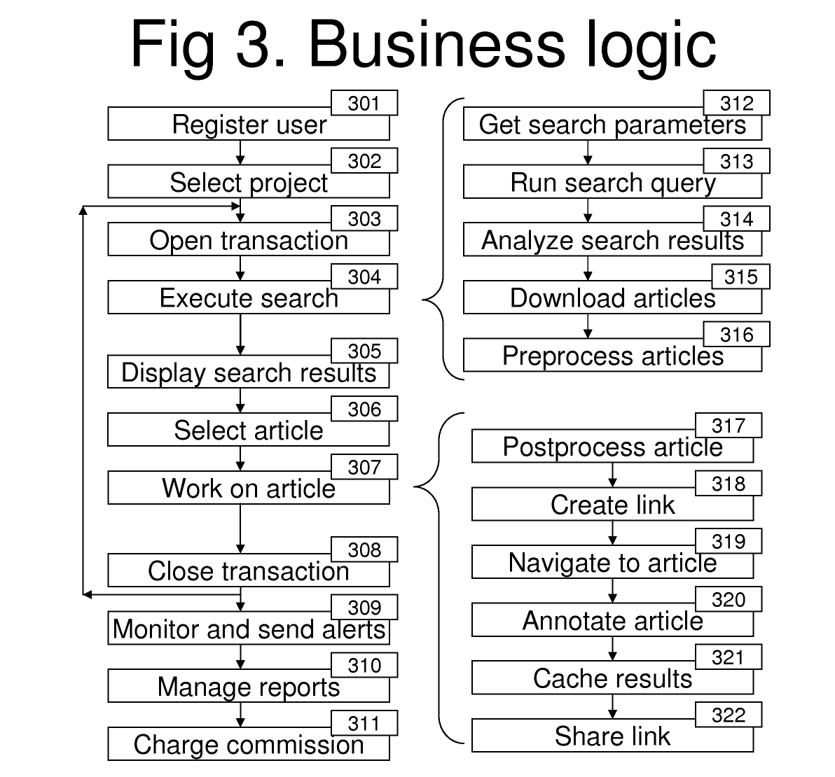

Block 201: Business logic, including methods for executing search knowledge management, as described on FIG. 3.

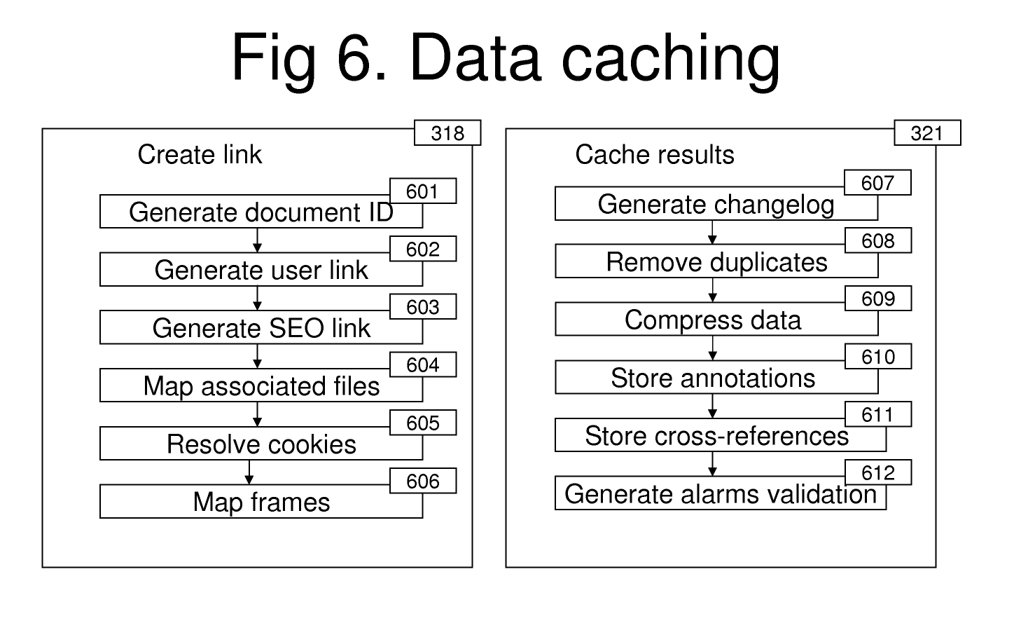

Block 202: Search engine interface, including methods for assisting with search query design, executing search queries, formatting search outputs, aggregating search sources and other suitable methods, as described on FIG. 6.

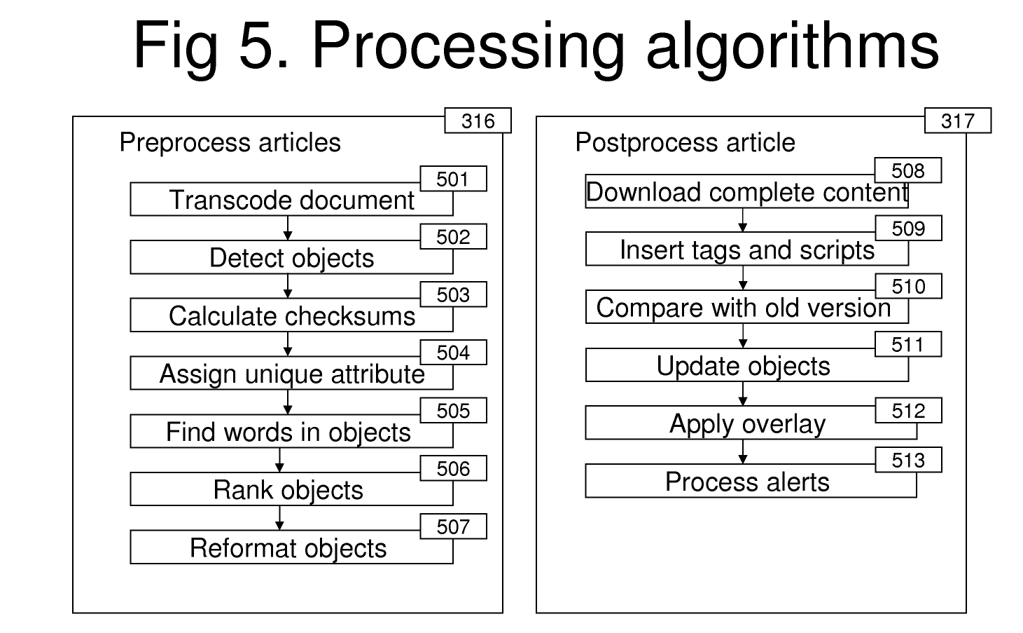

Block 203: Processing algorithms, including structured document analysis, transcoding, or other suitable methods, as described on FIG. 5.

Block 204: Data caching interface, including the distributed data storage, XML database interfaces, relational database interfaces and other suitable interfaces for storage of content and user data, providing statistics, compressing data, finding duplicate information and other suitable methods, as described on FIG. 6.

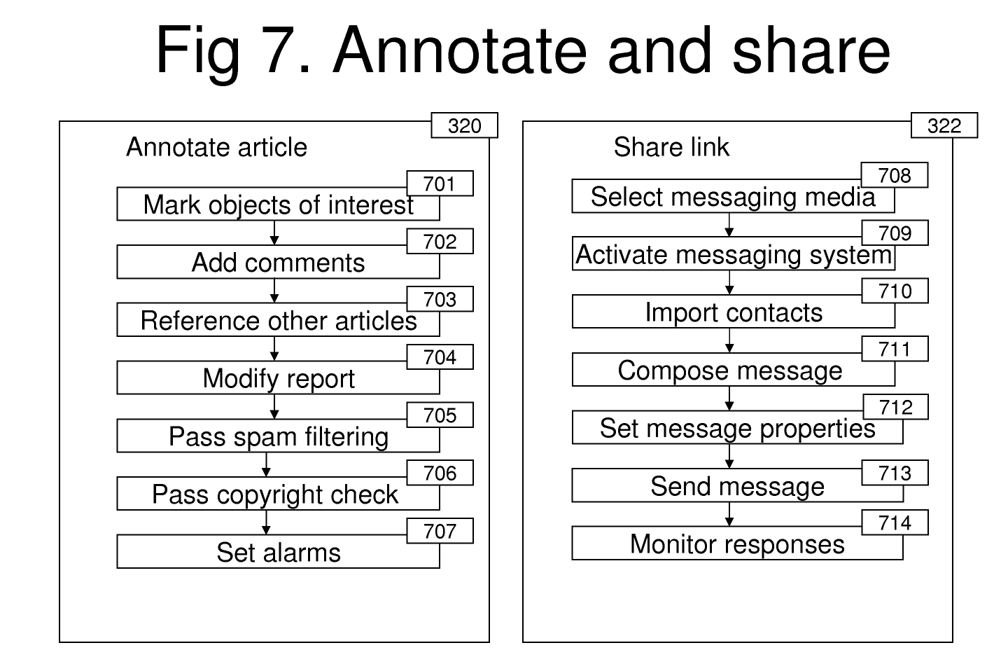

Block 205: Communication interface, including checking user permissions, import/export contacts, filtering data, monitoring sessions, activating messaging services 105, accessing social media 104, and other suitable methods as described on FIG. 7.

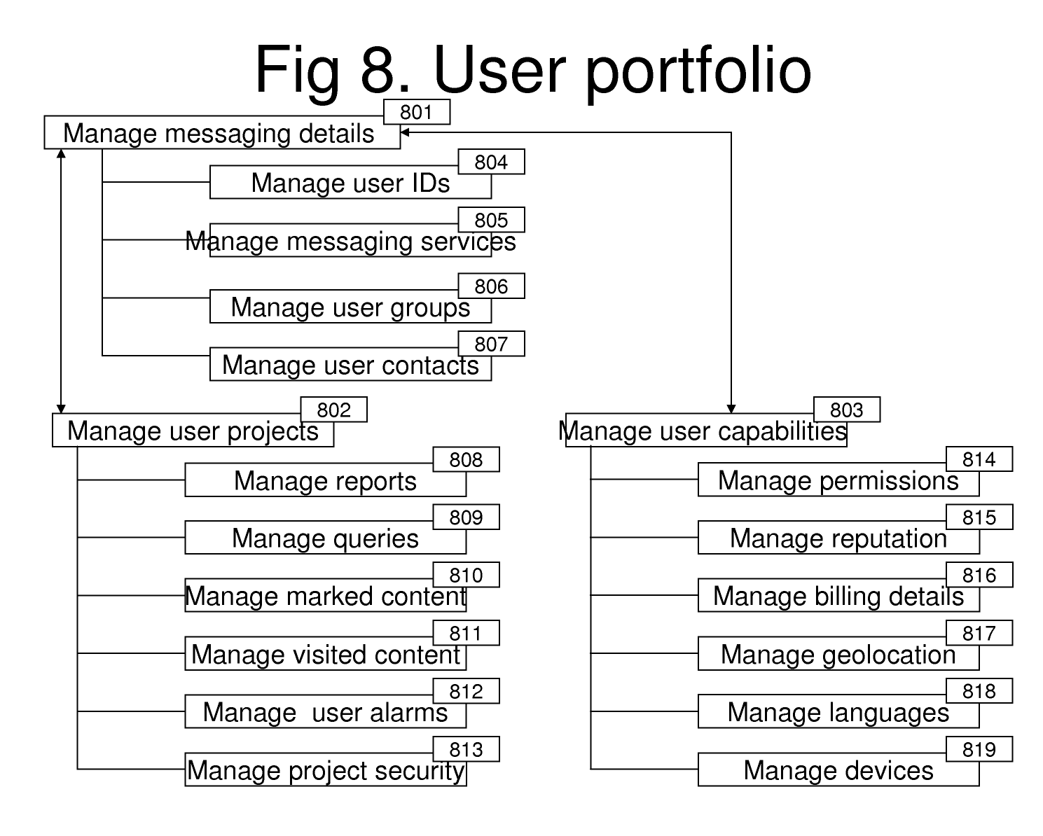

Block 206: User portfolio, including knowledge management interface, statistics, groups, projects, reports, reputation and other suitable interfaces and information, as described on FIG. 8.

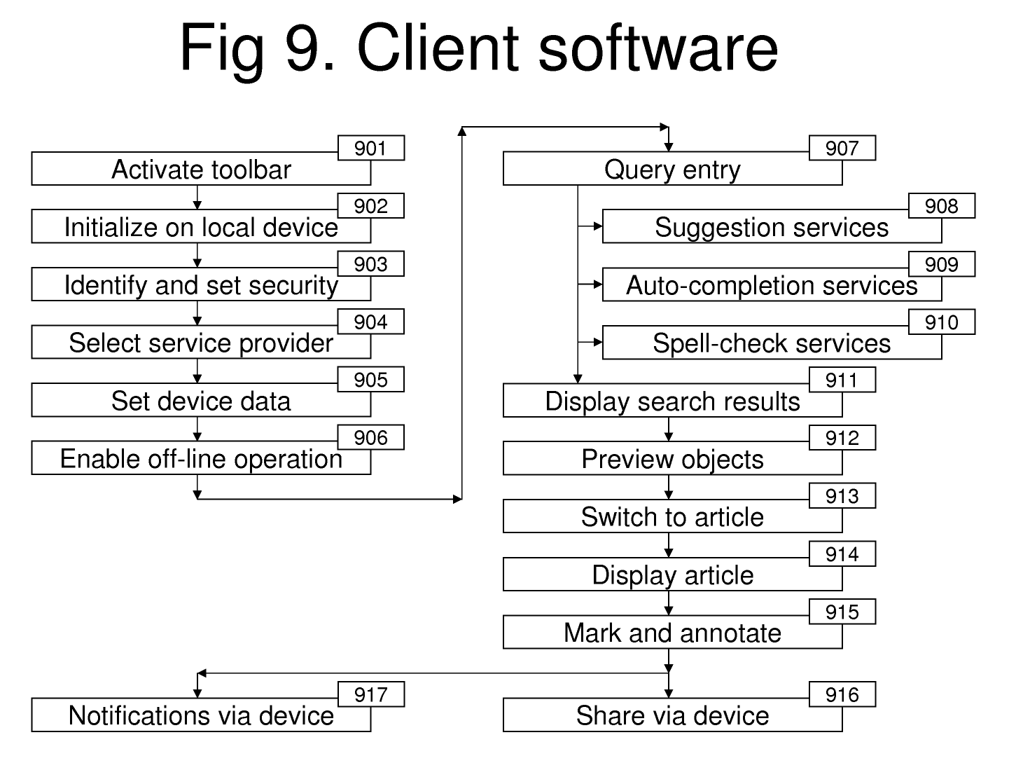

Block 207: Client software, implemented as a bookmarklet, plug-in, standalone application, browser-within-browser application or other suitable application. Client software may be hosted on local device. Alternatively, the client software may be evoked by the client and hosted by a search engine, website, network service provider, enterprise portal or other service provider. Client software may include annotation, URL disambiguation, cross-site navigation and other suitable methods and described on FIG. 9.

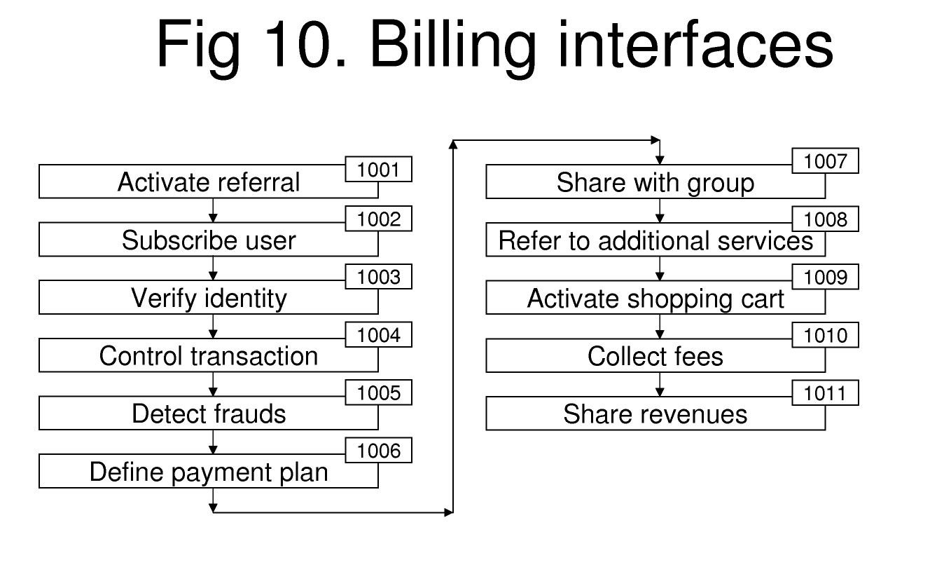

Block 208: Billing interface, including user permissions, transaction management, interfaces to payment systems, anti-fraud systems and other suitable interfaces and information, as described on FIG. 10.

FIG. 3 presents an embodiment of proposed business logic method, according to an embodiment of the invention. It is noted that various stages of the process of FIG. 3 may be incorporated into method, where applicable, even if not explicitly elaborated.

Phase 301: Register user. A user may register to the system, including user security authorization, user device capabilities, user geo-location, user personal preferences or other suitable user characteristics. In some embodiments user may register via login and password, OpenID™, hardware device such as mobile device SIM card, automatic registration via portal such as enterprise portal, or any other suitable registration process.

Phase 302: Select project. A user may select a project he may be working on. Each project may activate separate security and privacy setting, working group of users, project report, statistics, billing settings, searching services or other important settings.

Phase 303: Open transaction. A search transaction may have meanings for multiple databases in the system, including billing, group statistics, report status and other suitable data depositories. In some embodiments, the relevant statistics are updated when a transaction closes. The user may also finish activities without updating the statistics and closing the transaction.

Phase 304: Execute search. The search query may be optimized, search results received, found articles downloaded and analyzed, and the results may be prepared for display.

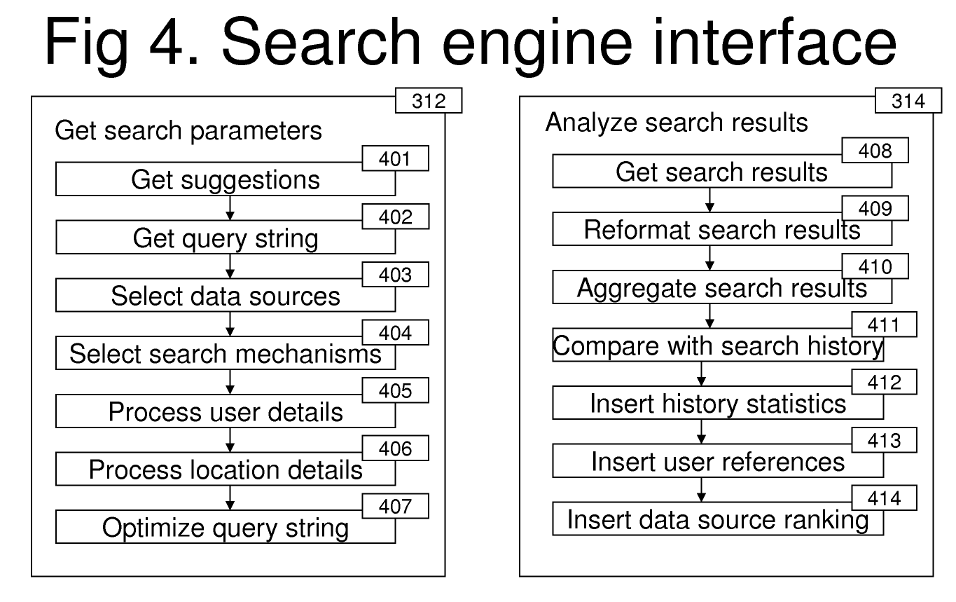

Phase 304 stage 312: Get search parameters, as described on FIG. 4.

Phase 304 stage 313: Run search query, including execution of the search by search engine 102.

Phase 304 stage 314: Analyze search results, as described on FIG. 4.

Phase 304 stage 315: Download articles, including download of articles, and recursive download of embedded frames, RSS feeds, Flash objects, or other suitable content. Download may be performed via multiple parallel connections. Download may be performed via browser-within-browser technology, enabling content consistency between user display on various devices and stored content on server. Download may be performed only on the new content or content modified since last search.

For example, multiple articles may be downloaded by the server from various content providers in parallel fashion via high-bandwidth interfaces. These articles of choice may be accessible by the user from the preview window, via the servers of the search results management system, w/o additional access to remote servers and content formatting, resulting in superior access to cached articles.

Phase 304 stage 316: Preprocess article, as described on FIG. 5.

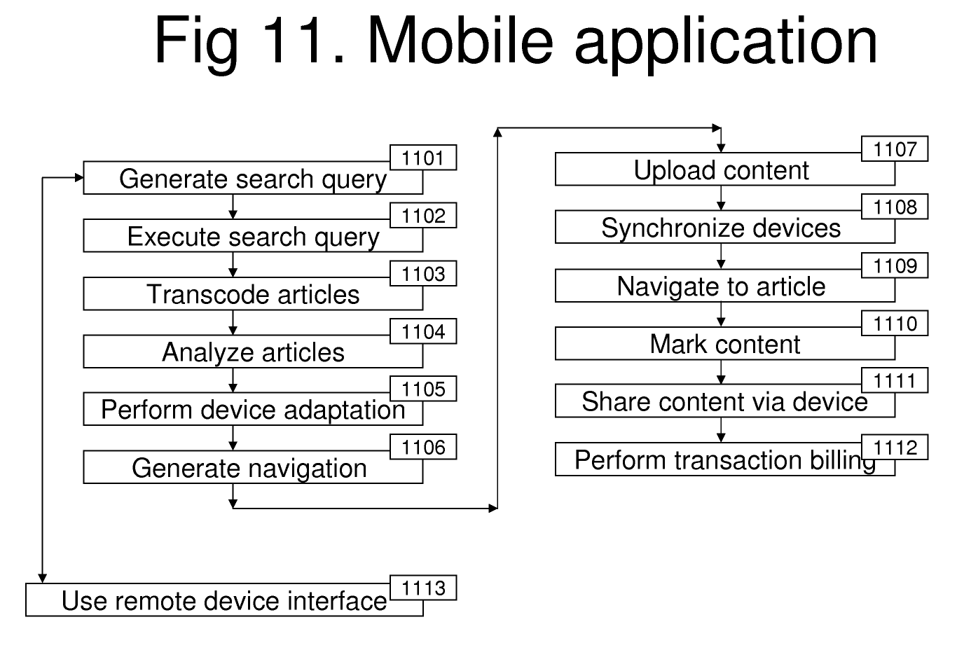

Phase 305: Display search results. Display the search results on the user device and enable user manipulation over the search results, including previewing various objects of the search results, seeing search statistics and reports, seeing previous search statistics, commenting and viewing previous comments, choosing the articles for deeper analysis, or other suitable manipulations, as described on FIG. 11.

Phase 306: Select article. The user selects article for further manipulation either manually by scrolling objects or automatically from highest ranking results. The user selection activates software, including client software 207, which enables further work on article.

Phase 307: Work on article, including navigation to the article, marking and commenting on the article, adding article to the report and sharing the article.

Phase 307 stage 317: Postprocess articles, as described on FIG. 5.

Phase 307 stage 318: Create link to the article, as described on FIG. 6.

Phase 307 stage 319: Navigate to the article, via navigation the link created in stage 318 and object anchor within the article. The anchors to the objects within the article may be created in stage 316. The navigation may be performed in the browser using client software 207. The navigation may be performed on the hosting server, if the server supports such navigation, for example via browser-within-browser technology.

Phase 307 stage 320: Annotate the article, as described on FIG. 7.

Phase 307 stage 321: Cache results, as described on FIG. 6.

Phase 307 stage 322: Share link, as described on FIG. 7.

Phase 308: Close transaction. In some embodiments the user may be able to rollback his search results or to commit the search result to the project-related depository. If the user rolls back the results, all the changes may be lost. If the user commits the results, the changes may be committed to the common depository, and suitable reports and statistics may be updated.

Phase 309: Monitor and send alerts. The user may activate alert mechanism, which sends alerts upon some preset events, including changes of selected objects, new search results, analysis committed by other group member or other suitable events.

Phase 310: Manage reports. The user may manually format, edit and analyze search reports, cross-reference various reports, verify underlying sources and references, publish the reports, export the reports to knowledge management system, CRM system integration or perform other suitable activity.

Phase 311: Charge commission for the project, transaction, subscription, or other suitable user activities, as described on FIG. 11, 12, 13.

FIG. 4 presents an embodiment of proposed processing algorithms.

The get search parameters stage 312 may consist of the following steps:

Stage 312 step 401: Get suggestions, including automatic completion services, alternative search words and sets of meanings, spelling correction or other suitable suggestion services. In some embodiments these services may be offered by search engine providers as complimentary services.

Stage 312 step 402: Get query string, including getting user query, and generating several query variations based on it, for example with the exact string query, queries with exact match on pairs of keywords, query with original text or other suitable queries. In some embodiments the user may specify the context of the search: product, person, article, invention or other suitable search context.

Stage 312 step 403: Select data sources, including target network (local device, collection or articles, private network, public network, internet etc.), target search area (product, invention, article etc.), locality of search (small radius, city, country, global) or other suitable settings.

Stage 312 step 404: Select search mechanisms, including the search engine provider and search engine for specific vertical. In some embodiments, the vertical for the search engine may be generated via data source selection 403.

Stage 312 step 405: Process user details, including languages, location, display preferences, search preferences, access rights to private resources, or other suitable information.

Stage 312 step 406: Process location details, including by way of illustration location calculation based on IP, GPS or mobile network.

Stage 312 step 407: Optimize query string, including by way of illustration optimization for target data source, search mechanism, user preferences and user location.

The analyze search results stage 314 may consist of the following steps:

Stage 314 step 408: Get search results, including monitoring the search provider, verifying that a set of results is returned, analyzing the format of the set of results, getting the raw results or performing similar operations.

Stage 314 step 409: Reformat search results for display to the user, including styling, highlighting or other similar activity.

Stage 314 step 410: Aggregate search results, including aggregating search results from several queries and search engines, separating various types of objects (text, image, video), separating sponsored results, aggregating multiple hits on one page, grouping similar hits or performing other analysis and grouping activity.

In some embodiments, the search results aggregation may be enabled via transcoding functionality. For example, links transcoding may be performed in order to display embedded images, so that the links point to known format on absolute URLs rather than original format at original URL.

Stage 314 step 411: Compare with search history, including comparison with the user, comparison within selected project, comparison to public data or other suitable comparison. In some embodiments, the comparison may be performed as a query on data depository 103. In some embodiments, the comparison is performed on multiple resolutions of the document, including domain, URL, the content, frame content and RSS feeds, sections, or other suitable granularity.

Stage 314 step 412: Insert history statistics, including time spent by the user on the page, contacts to other users which reviewed the page, user generated comments and ranking or other suitable statistics.

Stage 314 step 413: Insert user references, including public documents and reports referencing the article of interest, similar articles, recommended links or other suitable references.

Stage 314 step 414: Insert data sort ranking, including the ranking source of the content, user voting, or other suitable statistics.

FIG. 5 presents an embodiment of proposed search engine interface method.

The preprocess articles stage 316 may consist of the following steps:

Stage 316 step 501: Transcode document, including translation from proprietary document formats (Adobe Acrobat™, Adobe Flash™, MSWord™, MSPowerpoint™) into XML-like format (such as HTML). Transcoding may apply to the article and to parts of article (video, images).

Stage 316 step 502: Detect objects, including sections, paragraphs, tables, images or other suitable objects. The objects may be assigned unique identifier, checksum, annotation or other suitable information.

Stage 316 step 503: Calculate checksums for objects. The checksums may improve document comparison on several levels of granularity, may assist with generating unique object identifiers and be utilized for other suitable features.

Stage 316 step 504: Assign unique attribute for objects of interest. The unique attribute may be used for communication between client and server, database query, indexing or other suitable operation.

Stage 316 step 505: Find words in objects. The search operation may be performed in deeper resolution, than search supplied by the search engines. For example, the search may be performed on each object in the document. The search may be implemented in various forms. For example, in first phase the search may be performed per keyword, in second stage the statistics may be tuned for rarity of the keyword, and than in third phase ranking may be performed only on objects with keywords of interest based on word rarity statistics.

Stage 316 step 506: Rank objects, based of various search statistics, including number of words in an object, number of times the word of interest was found in an object, word rarity, properties of the object, visibility of the keyword or other suitable statistics. For example, in state of the art search engines, number of parameters for article ranking may be between 100 and 200.

Stage 316 step 507: Reformat objects, including adding overlay, writing unique attribute and checksum, highlighting keywords, ranking object, inserting control scripts or performing other formatting operation.

The post process articles stage 317 may consist of the following steps:

Stage 317 step 508: Download complete content, including downloading of the article of interest, downloading of embedded frames and objects, downloading of images, downloading of style documents, downloading of scripts or other suitable content download.

Stage 317 step 509: Insert tags and scripts, including object tags, control scripts, anchors, metadata or other suitable tags.

Stage 317 step 510: Compare with old version. For example, the checksums calculated in 503 may be used for comparison between tree branches.

Stage 317 step 511: Update objects, including applying stored versions of object identifiers, updating checksums and storing changelog. The changelog may enable statistical analysis of historic data and reverting data to historic form.

Stage 317 step 512: Apply overlay. The overlay may be applied using object identifiers, which may be preserved during update via step 511. The overlay may require computation of statistics, aggregation of comments or other suitable preprocessing.

Stage 317 step 513: Process alerts. The objects may be assigned with alerts-related overlay for user notification upon object value change, object review by other users, object statistics display or other object-related processing.

FIG. 6 presents data caching methods, according to embodiments of the invention. It is noted that some or all of the various stages illustrated in FIG. 6 may be incorporated as stages of method 2500, according to various embodiments of which, even if not explicitly elaborated.

The article or query may be cached per user request, or pre-cached following some caching policy. For example, sensitive data, including data passed by https protocol may be cached only upon user request. For example, commonly used queries may be pre-cached prior to user request based on known search trends, or cached by a different user in a group and shared with user of interest.

The create link stage 318 may consist of the following steps:

Stage 318 step 601: Generate document ID, including generation of unique index per selection of user and article, or other suitable criteria. In some embodiments, the document ID may be and index of an entry in XML database.

Stage 318 step 602: Generate user link, including a name and URL mapping visible to the user and representing the chosen link. For secure information, the user link may be session-dependant.

Stage 318 step 603: Generate SEO link, including a name and URL mapping visible to search engines and enabling search engine access to public data stored on the server. In some embodiments, the site structure may be updated dynamically to minor content generation, and uploaded to search engines.

Stage 318 step 604: Map associated files. In some embodiments, some files invoked by the document of interest and downloaded in step 508, may be stored on the server and available via file mapping to the links generated in steps 602 and 603. The file mapping may for example be performed via operating system.

Stage 318 step 605: Resolve cookies, for example by using server-side cookies solution, such as browser-within-browser system. In browser-within-browser systems, the relevant cookies may be stored on the server side.

Stage 318 step 606: Map frames, including recursive mapping of frames and objects within frames. For example, if the original article contains frames, flash objects, RSS feeds, redirection to other article or other complex content, the contained content may also be downloaded, processed and cached according to FIG. 3, recursively until all frames and other suitable complex content is processed and cached. For example, one may access objects within frames without cross-site scripting limitation, if the content of interest is bound to one server.

The cache results stage 321 may consist of the following steps:

Stage 321 step 607: Generate changelog, including objects added, objects deleted, objects modified, checksum modified or other suitable information. The changelog may be updated incrementally when the article of interest is modified. In some embodiment, each change is associated with object creation, modification and deletion dates.

Stage 321 step 608: Remove duplicates, for example via separate caching and indexing of duplicate objects and using pointers to the duplicate indices. In some embodiments, the duplicate content may be found via checksums calculated in step 503.

Stage 321 step 609: Compress data, for example using dictionary for tags and properties, using ZIP compression over stored data, or using other suitable compression methods.

Stage 321 step 610: Store annotations, including user comments and voting, user marking, responses by other users, time spent by the user on the site, user comments, or other suitable annotation.

Stage 321 step 611: Store cross-references, including cross-references to frames in 606, cross-reference to partially duplicated content from 608, references to user-generated reports, or other suitable references.

Stage 321 step 612: Generate alarm validation, including periodic revisit of the content of interest and monitoring the differences, statistics generation, user notification, user reminder or other suitable alarm processes.

FIG. 7 presents an embodiment of proposed annotation and messaging methods. It is noted that some or all of the various stages illustrated in FIG. 7 may be incorporated as stages of method 2500, according to various embodiments of which, even if not explicitly elaborated.

The annotate article stage 320 may consist of the following steps:

Stage 320 step 701: Mark objects of interest, for example add elliptic or rectangular overlay shape over the outlines of the object of interest.

Stage 320 step 702: Add comments, such as text comments on the object of interest, attachment documents, comments to comments of other users or other suitable comments.

Stage 320 step 703: Reference other articles, for example via links to other URLs, report document, or other suitable resource.

Stage 320 step 704: Modify report, for example by adding user comment to the report, adding link to the article in the report's citation list, recalculating report's statistics or other suitable modification.

Stage 320 step 705: Pass spam filtering, including sexual references, bad language, fraud check-up or other suitable filtering. The filtering may be performed via rule sets based on keywords, user IP, user reputation, language and other suitable statistics.

Stage 320 step 706: Pass copyright check. For example, if some part of article was previously banned, checksum-based comparison may be performed.

Stage 320 step 707: Set alarms. For example, the user may decide to be notified when the content of interest is read or commented on.

The share link stage 322 may consist of the following steps:

Stage 322 step 708: Select messaging media, including for example e-mail, blog, SMS, social network or other suitable media. The selection may be performed by the user manually, or automatically based on user profile.

Stage 322 step 709: Activate messaging system, including establishing communication protocol with messaging platform, supplying user details, single-sign-on procedure or performing other suitable operations.

Stage 322 step 710: Import user contacts, including contacts previously entered by the user, contacts stored on local device, e-mail service, list of group members, or other suitable contact data source.

Stage 322 step 711: Compose a message, including automatic message creation based on user annotation and user profile, which may be manually edited by the user.

Stage 322 step 712: Set message properties, including encoding, privacy level, notification level, delivery priority, forwarding limitations, or other suitable parameters.

Stage 322 step 713: Send message via selected media.

Stage 322 step 714: Monitor responses and notify the user upon read receipt, response, message not reaching destination or other suitable events.

In some embodiments, monitoring may include dynamic update of the message content as the original article is modified, notification of the user upon changes in the original article, capabilities of reverting to older versions of original document, graphical display of changes in the chosen article or other suitable article monitoring.

FIG. 8 presents an embodiment of proposed user portfolio management method. It is noted that some or all of the various stages illustrated in FIG. 8 may be incorporated as stages of method 2500, according to various embodiments of which, even if not explicitly elaborated.

Stage 801: Manage messaging details, including the following steps.

Stage 801 step 804: Manage user IDs, including login and password, security settings, fraud detection, user identity verification or other suitable methods.

Stage 801 step 805: Manage messaging services, including user accounts on various messaging services, user messaging capabilities, user messaging settings or other suitable properties.

Stage 801 step 806: Manage user groups, including the groups which work on projects with user, groups which can be read by the user, groups which were marked by the user, or other suitable groups.

Stage 801 step 807: Manage user contact, including contact import/export, caching of contacts from incoming messages, caching of manually entered contacts, management of contacts of group members or other suitable contact management.

Stage 802: Manage user projects, including the following steps.

Stage 801 step 808: Manage reports, including reports partially or fully written by the user, reports the user may access, reports the user marked for further analysis or other suitable reports.

Stage 801 step 809: Manage queries, including historical queries run by the user and some analysis of query results, for example amount of time spent on each query and amount of marked content it produced.

In some embodiments, the credentials of the user which first found the information of interest may be added to the information of interest as a digital signature, including credits for the search and search analysis.

Stage 801 step 810: Manage marked content, including content marked by the user, content marked for the user, content selected by user and marked by others or other suitable marked content.

Stage 801 step 811: Manage visited content, including the contacts seen by the user as query result, the content manually examined by the user, the content examined by the user in-depth, the content the user voted on, amount of time user spent reviewing the content or other suitable information.

Stage 801 step 812: Manage user alarms, including revisiting selected pages, user notification upon changes, messaging system status notification, reminders, user notification upon actions of other users or other suitable alarms.

Stage 801 step 813: Manage project security, including access rights to projects, project encoding, project visibility to search engines or other suitable project security information.

Stage 803: Manage user capabilities, including the following steps.

Stage 801 step 814: Manage permissions, including user rights to access various types of information, user security status, user rights as group manager, other suitable user permissions.

Stage 801 step 815: Manage reputation, including user reputation derived from security status, history depth, user activity status or other suitable information.

Stage 801 step 816: Manage billing details, including shopping card integration, payment cards, previous transactions status or other suitable details.

Stage 801 step 817: Manage geolocation, including user IP, home address, work address, mobile device location, or other suitable location.

Stage 801 step 818: Manage languages, including search preferences, translation preferences, GUI preferences or other suitable preferences.

Stage 801 step 819: Manage devices, including list of devices previously used by the user, device properties, selected browsers, transcoding settings, display capabilities, computer language support or other suitable properties.

FIG. 9 presents an embodiment of proposed client software methods. It is noted that some or all of the various stages illustrated in FIG. 9 may be incorporated as stages of method 2500, according to various embodiments of which, even if not explicitly elaborated.

Stage 901: Activate toolbar, including activation of browser toolbar, bookmarklet, button on remote website, web application, or any other suitable activation.

Stage 902: Initialization on local device, including establishing communication channel, update of software version, synchronization with stored profile, or other suitable operation.

Stage 903: Identify and set security, including login and password, setting security level, establishing protocol or other security-related operations.

Stage 904: Select service provider, including search engine service and data source, or other suitable information.

Stage 905: Set device data, including device type, browser type, display capabilities, geolocation or other suitable data.

Stage 906: Enable offline operation, via local caching of some search results. For example software systems like Google Gears™, Silverlight™ and Adobe AIR™ may enable off-line device operation.

Stage 907: Query entry by the user assisted via client software.

Stage 907 step 908: Suggestion services, including suggestion services via search engine, may assist user with filling the query.

Stage 907 step 909: Auto-completion services, including services based on spell-check, may assist user with filling the query.

Stage 907 step 910: Spell-check services may assist the user with different spelling alternatives of the content.

Stage 911: Display search results, including search results formatted and transcoded for target device, overlay of statistics and search history or other suitable search result display.

Stage 912: Preview objects, including preview of pre-ranked transcoded objects, navigation between objects, object ranking overview, highlight of found words comments on objects or other suitable display methods.

Stage 913: Switch to article, including activation of article in a new window, replacement of article content with content stored on remote device, activation of browser-within-browser technology, or other suitable method.

Stage 914: Display article, including display of article transcoded to target device, user toolbar, article statistics, user overlays or other suitable content display.

Stage 915: Mark and annotate, including activation of graphical marking libraries, usage of overlays, user selection activation, highlighting, text comments, or other marking services.

Stage 916: Share via device, for example using SMS capabilities of mobile device.

Stage 917: Notification via device regarding alarms, including for example, SMS, e-mail, IMS or other messaging service.

FIG. 10 presents an embodiment of proposed billing interface methods. It is noted that some or all of the various stages illustrated in FIG. 10 may be incorporated as stages of method 2500, according to various embodiments of which, even if not explicitly elaborated.

Stage 1001: Activate referral, including referrals from web sites, search engines, and other suitable sources. When user reaches the site via referral site or service, there might be payback to the original site associated with user redirection.

Stage 1002: Subscribe user. If the user is subscribed, it may be sufficient for the user to sign in, otherwise user account may be opened with relevant details as described on FIG. 8.

Stage 1003: Verify identity of the user, including credit card verification, verification via third-party services, e-mail-based account activation, or other suitable services.

Stage 1004: Control transaction, including opening a transaction and enabling user to commit or rollback the transaction, as described on FIG. 3, charging per transaction, selective permissions to open transaction, or other suitable services.

Stage 1005: Detect frauds, using third-party services, IP data, user profile, usage statistics, resource utilization, user requests or other suitable methods.

Stage 1006: Define payment plan, including subscription fees, quality of service, revenue sharing on user generated content, referral payment or other suitable plan.

Stage 1007: Share with group, including floating licenses, revenue sharing, group licenses, group discount, inter-group communication discount or other suitable group program.

Stage 1008: Refer to additional services, including affiliation with search engines, ad networks, e-commerce sites, web services and content relevant to activated queries, or other suitable referral.

Stage 1009: Activate shopping cart, including integration with shopping carts of the target website, built-in shopping-cart capabilities, or other suitable shopping cart.

Stage 1010: Collect fees, using shopping cart, credit card, associated payment service (e.g. PayPal™) or other suitable service.

Stage 1011: Share revenues, including pay-back to referring site, user pay-back, or other suitable revenue sharing program.

FIG. 11 presents an embodiment of proposed mobile application methods. It is noted that some or all of the various stages illustrated in FIG. 11 may be incorporated as stages of method 2500, according to various embodiments of which, even if not explicitly elaborated.

Stage 1101: Generate search query, including usage of suggestion and autocompletion software (client and server combination) or other suitable services. In mobile application the user's input capability is limited and saving input effort may be very usable.

Stage 1102: Execute search query via the search engine. In clients that enable dynamic update of content (AJAX), the search results may be downloaded at this stage and updated via ranked objects. For clients that do not enable dynamic update of content, the search results may be downloaded with the ranked objects.

Stage 1103: Transcode articles on the remote server to the formats enabled on local device.

Stage 1104: Analyze articles, including finding keywords and ranking objects of interest.

Stage 1105: Perform device adaptation, including dynamic update of search results if available, creation of object directory for client device, formatting of search results and other suitable adaptations.

Stage 1106: Generate navigation, including navigation to target mini-pages transcoded from the original articles, navigation between objects or other suitable control features. In some embodiments, dedicated links are generated for all navigation scenarios.

Stage 1107: Upload content to local device. Due to transcoding and object ranking, the amount of uploaded content may be significantly reduced, enabling bandwidth saving and fast response time.

Stage 1108: Synchronize devices, including synchronization of contact details, software versions, or other suitable software.

Stage 1109: Navigate to article, via links created in stage 1106.

Stage 1110: Mark content, via methods supported by local device. For example, some local device may nor support graphical marking, but may support background color modification.

Stage 1111: Share content via local device, including sending SMS/MMS, sharing via web interface or other sharing methods.

Stage 1112: Perform transaction billing, including generating billable transaction on cellular operator billing software, or other suitable billing option described by payment plan in 1006.

Stage 1113: Use remote device interface. For example, the client software may be deployed remotely from the local device, and the communication between the remote device and client software may be performed using video call interface or other suitable remote interface.

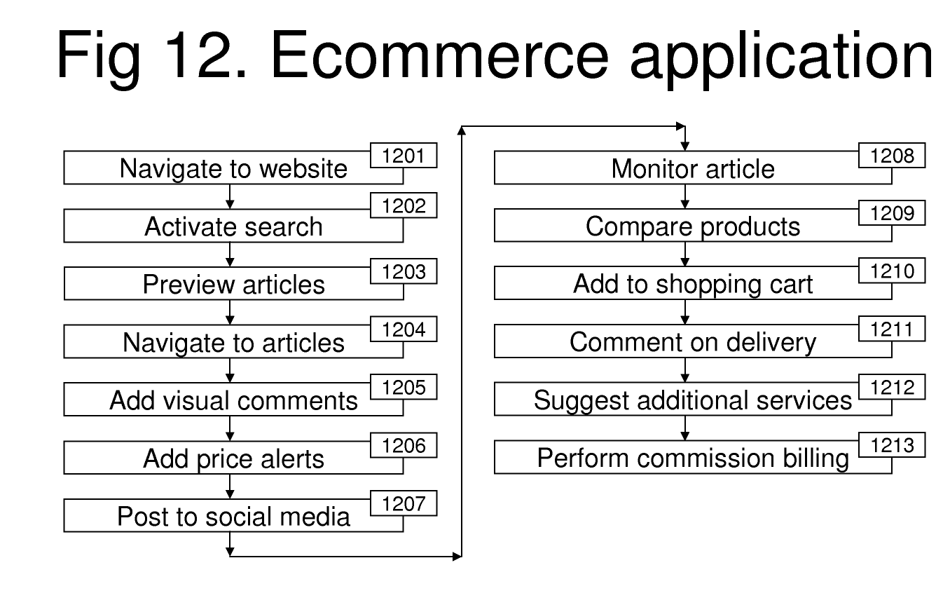

FIG. 12 presents an embodiment of proposed e-commerce application methods. It is noted that some or all of the various stages illustrated in FIG. 12 may be incorporated as stages of method 2500, according to various embodiments of which, even if not explicitly elaborated.

Stage 1201: Navigate to website, including referral from third-party service, manual navigation, search-engine navigation, toolbar activation or other suitable navigation method.

Stage 1202: Activate search, including activation from a button in the website, a button on client toolbar, or other suitable activation method.

Stage 1203: Preview article, including viewing items of interest and short metadata associated with items of interest, as defined by objects analysis and ranking.

Stage 1204: Navigate to articles, for example using navigation inside the website. In some embodiments, the content supplied by website a-priori includes the tags required for efficient operation of content marking methods. For example, the site construction process may include passing all pages of interest via content analysis and tag insertion.

Stage 1205: Add visual comments, for example mark features of interest and add a short description of user requirements, add reference to other similar products and to product comparison reports or add other suitable commentary.

Stage 1206: Add price alert, including monitoring item price and notifying user when the price is changed.

Stage 1207: Post to social media, including group sales, request for social commentary, common decision-making software, vanity site or other suitable social media.

Stage 1208: Monitor article, including monitoring social media remarks, monitoring price changes, sending reminders regarding buying intent, referring to new associated products or other suitable monitoring activity.

Stage 1209: Compare products, including manual construction of feature comparison tables, automatic object comparison based on data stored on site database, review of social media responses, or other suitable object comparison method.

Stage 1210: Add to shopping cart, including completion of buying process on selected products.

Stage 1211: Comment on delivery, including platform for customer feedback on service and delivery of the marked product.

Stage 1212: Suggest additional services, including complementary products, maintenance services, delivery services or other suitable services.

Stage 1213: Perform commission billing Perform billing based on sales commission, referral fee, or any other suitable billing.

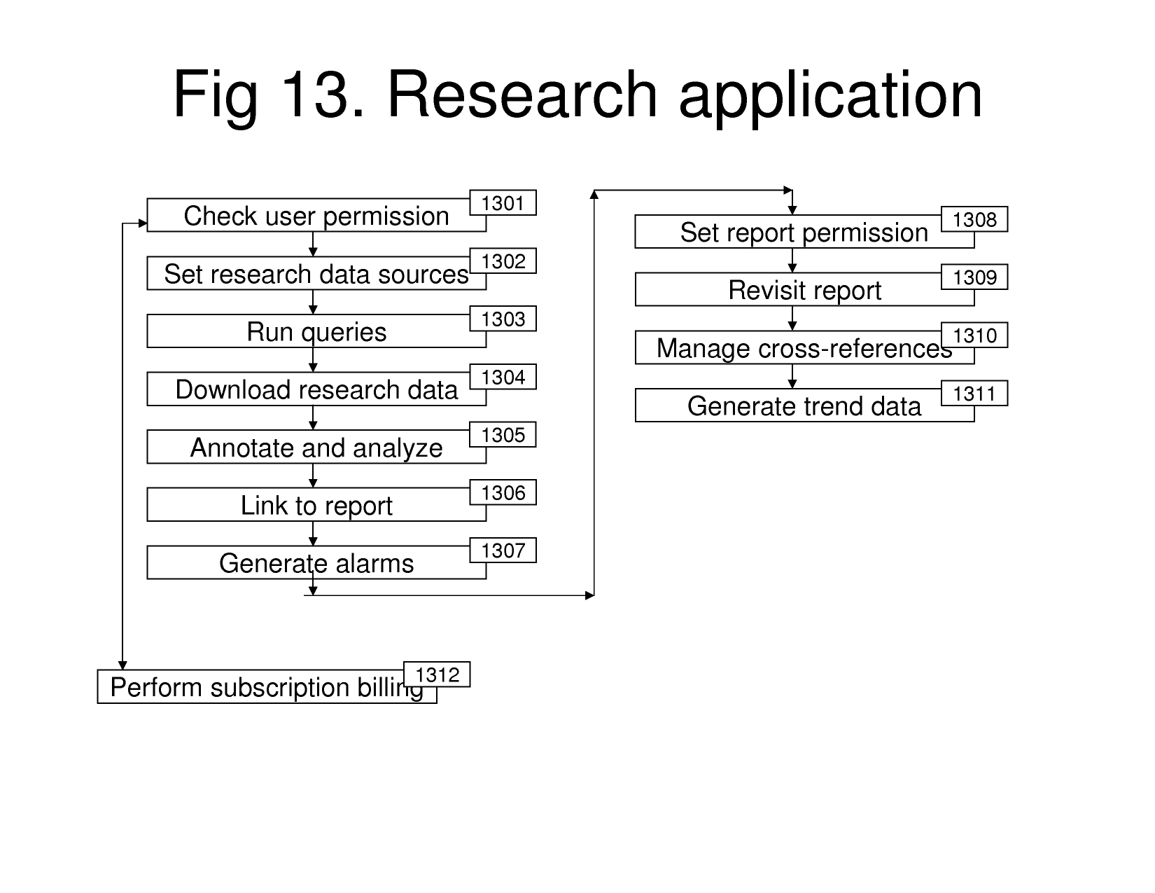

FIG. 13 presents an embodiment of proposed research application methods. It is noted that some or all of the various stages illustrated in FIG. 13 may be incorporated as stages of method 2500, according to various embodiments of which, even if not explicitly elaborated.

Stage 1301: Check user permission, for example check if user may access some secure data repository, what projects the user may have read or write access permissions, security levels of active projects or other suitable security information.

Stage 1302: Set research data sources, including research repositories, search engines verticals, or other suitable data source information.

Stage 1303: Run queries, including running several query variations for selected data sources and aggregating search results.

Stage 1304: Download research data, including download of search statistics, download of formatted search results, download of selected articles or other suitable download process.

Stage 1305: Annotate and analyze, including marking of objects, generating manual analysis on objects of interest, adding comments and comments on comments, generating object-specific action items or other analysis.

Stage 1306: Link to report, including creation of cross-reference between research report and selected data objects, editing research reports or performing other suitable activity.

Stage 1307: Generate alarms, including automatic notification upon changes in search query results, comments on research reports, or other suitable events.

Stage 1308: Set report permission, including security settings, authorization plan and payment plan for accessing the report.

Stage 1309: Revisit report, including manual analysis of the report and report summary, annotation inside the body of report, recalculation of statistics or other suitable operation.

Stage 1310: Manage cross-references, including establishing citation order between various duplicate content scenarios, analyzing citation indices, examining links embedded in the objects of interest, or performing other suitable activity.

Stage 1311: Generate trend data, including automatic check-up of objects and updates for statistic calculation, statistics of alarms, access to reports, common search keywords, statistics on duplicate content, or other suitable statistic parameters.

Stage 1312: Perform subscription billing, including payment for subscription to research services, subscription to specific databases, or other suitable subscription.

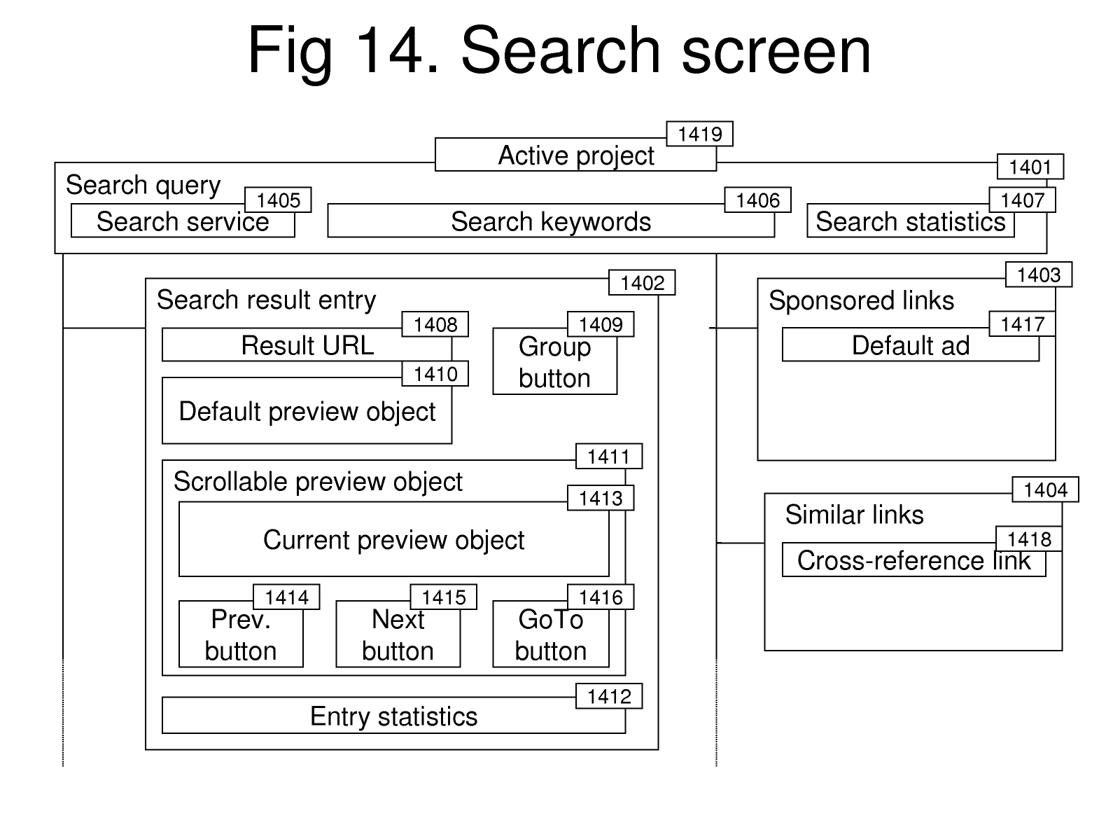

FIG. 14 presents an embodiment of proposed search results display, which may be implemented, inter alia, in various embodiments of system 3000 and/or method 2500. The search results screen may include several display areas with several controls in each.

Area 1401 search query, including controls relevant to the whole query, such as:

Area 1401 control 1405: Search service, including search data sources, search engine provider, semantic clues or additional suitable search information.

Area 1401 control 1406: Search keywords, including entry for search keywords, search logic, auto-suggestion, auto-completion or additional suitable search information.

Area 1401 control 1407: Search statistics, including time spent on analyzing the query, number of query results, relevance of the query results or additional suitable search information.

Area 1401 control 1419: Active project, including name of currently active project the user may be working on.

Area 1402 search result entry. Each query may return plurality of search result entries for further analysis.

Area 1402 control 1408: Result URL, including URL of the site where the content was found.

Area 1402 control 1409: Group button, enabling viewing similar results from the results got by group members.

Area 1402 control 1410: Default preview object, including preview area supplied by the search engine.

Area 1402 group 1411: Scrollable preview area, including objects of interest and switching between them.

Area 1402 group 1411 control 1413: Current preview object, including the objects that contain keywords, formatted for display purposes.

Area 1402 group 1411 control 1414: Prev. button provides navigation to objects with higher rank.

Area 1402 group 1411 control 1415: Next button provides navigation to objects with lower rank.

Area 1402 group 1411 control 1416: Goto button provides navigation to the article. In some embodiments, the navigation may be provided to the object of interest using object's anchor tags. The single-click navigation to actions of choice, including target object in target article, shopping cart object or widget of choice may be convenient for users of the invention.

There may be alternative implementation of the scrollable preview object 1411, including:

Variation 1: Display of fixed number (e.g. 3) of highest ranking candidates.

Variation 2: Tabs for candidates display and switching between candidates.

Variation 3: Thumbnail display of candidate objects.

In some embodiments, the objects displayed in the scrollable preview object 1411, are subjected to formatting specifically for the purpose of display in the scrollable preview object 1411. For example, the replace all styles in the original object with default styles which enable efficient display on target device.

Area 1402 control 1412: Entry statistics, including rating of the chosen entry, time spend analyzing the entry, number of found objects, relevance level (and not search engine rank) or other suitable statistics.

Area 1403: Sponsored links, including plurality of advertising links 1417.

Area 1402 control 1417: Default ad included advertising provided by search engines, links provided by server for referral purposes or other suitable links.

Area 1404: Similar links, including plurality of links 1418.

Area 1402 control 1418: Cross-reference link, including links similar to the object of interest, links to report or cross-referenced with object of interest.

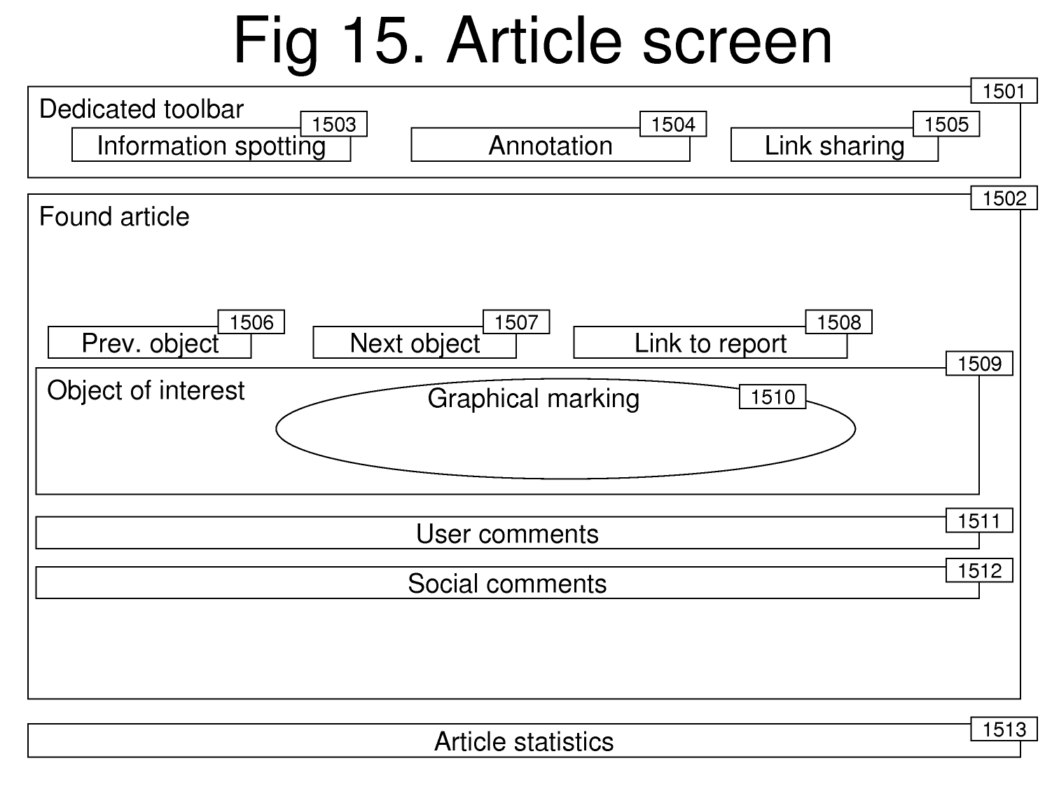

FIG. 15 presents an embodiment of proposed article content display, which may be implemented, inter alia, in various embodiments of system 3000 and/or method 2500. The search results screen may include several display areas with several controls in each.

Area 1501: Dedicated toolbar, including several control buttons.

Area 1501 control 1503: Information spotting, including search within document, search web, scroll the document and mark object of interest, or other suitable method.

Area 1501 control 1504: Annotation, including highlights, geometric shapes, text, vote, alarm or other suitable annotations.

Area 1501 control 1505: Link sharing, including interface to various messaging services.

Area 1502: Display area of the found article, including several objects, some of them marked, one of them object of interest.

Area 1502 control 1506: Prev. object, including navigation to higher-ranking object.

Area 1502 control 1507: Next object, including navigation to lower-ranking object.

Area 1502 control 1508: Link to report, including navigation to research report.

Area 1502 control 1509: Object of interest.

Area 1502 control 1510: Graphical marking on object of interest.

Area 1502 control 1511: User comments, including comments written by the user.

Area 1502 control 1512: Social comments, including comments written by other users.

Area 1513: Article statistics, including number of lines, number of words, number of marked objects, ranking, time spent on the article or other suitable statistics.

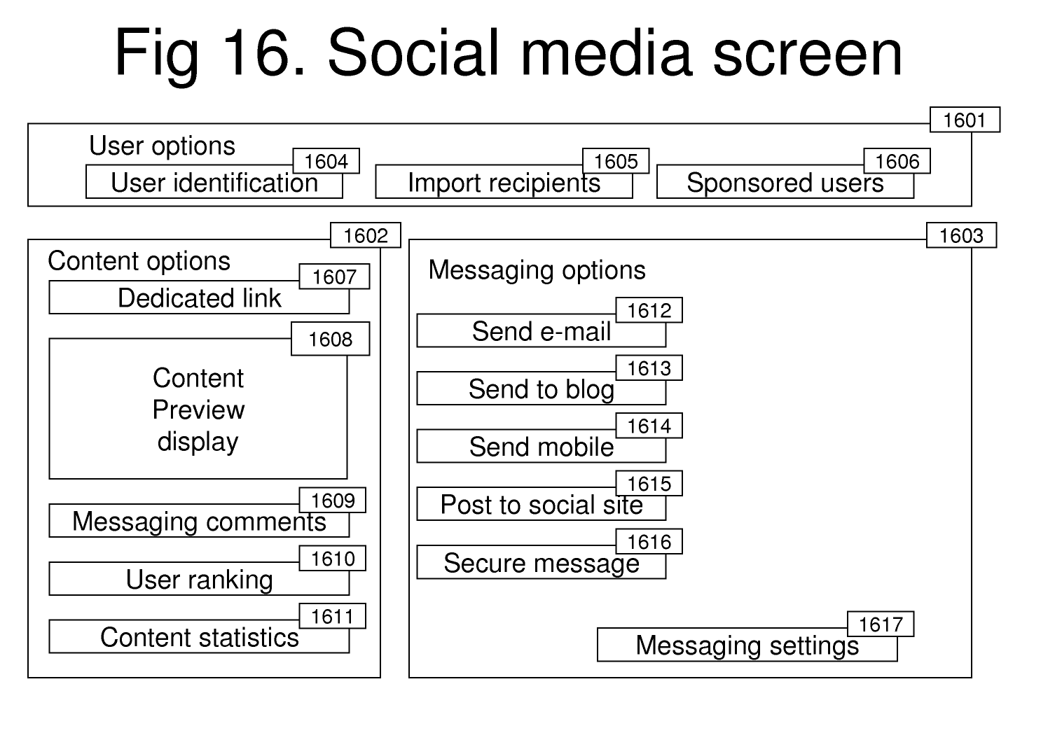

FIG. 16 presents an embodiment of proposed messaging display, which may be implemented, inter alia, in various embodiments of system 3000 and/or method 2500. The search results screen may include several display areas with several controls in each.

Area 1601: User options, including various controls of user portfolio.

Area 1601 control 1604: User identification, including login, e-mail, photo or other suitable properties.

Area 1601 control 1605: Import recipients from webmail, mobile device, personal mail program or other suitable data repository.

Area 1601 control 1606: Sponsored users, including users with similar tastes, users with similar personal details, users in the same groups, or other sponsored users.

Area 1602: Content options, including options for content manipulation.

Area 1602 control 1607: Dedicated link, including dynamically generated links for specific messaging purposes.

Area 1602 control 1608: Content preview display, including preview of selected object.

Area 1602 control 1609: Messaging comment, including comments added by user specifically for messaging purposes.

Area 1602 control 1610: User ranking, including user opinion regarding sent content, for example as favicon (smiley etc).

Area 1602 control 1611: Content statistics, including content popularity or other suitable statistics.

Area 1603: Messaging options, including options for messaging manipulations.

Area 1603 control 1612: Send e-mail, including sending the content of interest to e-mail recipient.

Area 1603 control 1613: Send to blog, including short line to be included in a blog or website.

Area 1603 control 1614: Send mobile, including by SMS/MMS.

Area 1603 control 1615: Post to social site, including social networks and recommendation sites.

Area 1603 control 1616: Secure message, including disabling third party communication using the message, cloaking the message to search engines, or other suitable security measures.

Area 1603 control 1617: Messaging settings, including priority, notification, or other suitable settings.

It is noted that different methods and systems discussed above may be implemented in different ways, including software, hardware, firmware, and any combinations of the above. Computer readable mediums having computer readable codes embodied therein for the carrying out of processes and/or methods and/or functionalities as discussed above may be used for implementing the invention.

With respect to the above description, it is to be realized that the optimum dimensional relationships for the parts of the invention, to include variations in size, form, function and manner of operation, integration and use, are deemed readily apparent and obvious to one skilled in the art, and all equivalent relationships to those illustrated in the drawings and described in the specification are intended to be encompassed by the present invention.

Therefore, the foregoing is illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The present invention can be practiced by employing conventional tools, methodology and components. Accordingly, the details of such tools, component and methodology are not set forth herein in detail. In the previous descriptions, numerous specific details are set forth, in order to provide a thorough understanding of the present invention. However, it should be recognized that the present invention might be practiced without resorting to the details specifically set forth.

Only exemplary embodiments of the present invention and but a few examples of its versatility are shown and described in the present disclosure. It is to be understood that the present invention is capable of use in various other combinations and environments and is capable of changes or modifications within the scope of the inventive concept as expressed herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method, comprising:
receiving from a search engine information that pertains to at least one document, wherein the at least one document is selected by the search engine in response to at least one search query;
dividing the at least one document into multiple granular elements in response to content of the at least one document;
ranking the granular elements in response to query parameters, and
providing, in response to the ranking of the granular elements, search results that comprise at least one of the ranked granular elements.

2. The method according to claim 1, wherein the dividing of the at least one document is further responsive to at least one of the query parameters.

3. The method according to claim 1, wherein the dividing of the at least one document is further responsive to previously gathered user parameters of a user to which the search results are provided.

4. The method according to claim 1, wherein all of the multiple granular elements of the search results provided belong to a single document, wherein the receiving, the ranking and the providing are triggered by a single query of the user.

5. The method according to claim 1, wherein the providing of the search results comprises providing search results that comprise multiple granular elements and metadata indicative of relationships between the multiple granular elements.

6. The method according to claim 1, wherein the ranking is responsive to relationships between different granular elements, wherein the method further comprises determining, prior to the ranking, relationships between granular elements in response to content of the at least one document.

7. The method according to claim 1, further comprising recording, for each granular element out of multiple granular elements that belong to multiple documents, search history information that pertains to search results of different users that comprised the granular element; wherein the ranking is further responsive to the search history information of multiple granular elements.

8. The method according to claim 1, further comprising recording, for each granular element out of multiple granular elements that belong to multiple documents, enrichment information received from users that reviewed the granular element and which pertains to the granular element; wherein the ranking comprises ranking the granular elements in response to enrichment information of multiple granular elements.

9. The method according to claim 1, further comprising recording, for each granular element out of multiple granular elements that belong to multiple documents, query history information that indicates at least one query which retrieved the granular element; and providing information which is determined in response to the query history information of multiple granular elements.

10. The method according to claim 1, further comprising creating semantic tags for multiple granular elements, wherein the providing of the search results comprises providing a tag cloud that comprises semantic tags of ranked granular elements, wherein the semantic tags are selected in response to the query parameters.

11. The method according to claim 1, further comprising providing search results that comprise group of granular elements that are selected in response to query parameters of multiple queries, wherein the search results provided further comprise relationships between the granular elements that are determined in response to query parameters.

12. The method according to claim 1, further comprising generating a structured document that comprises multiple semantically distinctive portions; and incorporating into the structured document granular elements of multiple documents which were selected in response to ranking of the granular elements.

13. The method according to claim 1, further comprising evaluating effectiveness of multiple queries, and providing query effectiveness summary that is responsive to the evaluated effectiveness of the multiple queries.

14. The method according to claim 1, further comprising ranking granular elements at different times using the same query parameters, and providing search results indicative of changes in the ranking results at the different times.

15. The method according to claim 1, further comprising suggesting query parameters in response to results of the ranking.

16. The method according to claim 1, further comprising finding different documents that comprise multiple similar granular elements, and providing search results indicative of the found documents.

17. The method according to claim 1, further comprising providing to an informed user information of the search results of a searching user that provided the query parameters.

18. The method according to claim 1, further comprising generating structured trees wherein each of the structured trees comprises multiple granular elements, and wherein the structure of each of the structured trees is responsive to relationships between the granular elements of the structured tree; and ranking the structured trees in response to the ranking of the granular elements of each of the structure trees and in response to the relationships between those granular elements; wherein the providing comprises providing search results that comprise at least one ranked structured tree.

19. The method according to claim 1, further comprising providing a search results report that comprises the search results and at least one calculated key indicator, wherein the key indicator is selected from a group consisting of semantic information, significancy value, and size.

20. The method according to claim 19, further comprising providing additional search results that are responsive to at least one of the key indicators provided for preceding search results.

21. The method according to claim 1, further comprising modifying, after the providing of the search results, a search results report, wherein the modifying is responsive to at least one of the key indicators calculated for at least one other report.

22. The method according to claim 1, wherein the method is reiterated, so that in a second reiteration the receiving of the information that pertains to the at least one document comprises receiving information from a search results that were provided in a first iteration.

23. The method according to claim 1, further comprising providing a search results report that comprises the search results constructed in response to a first template, wherein the constructing is preceded by creating the first template by modifying a second template used for the construction of another search report.

24. The method according to claim 23, further comprising determining billing value for the purchasing of the second template.

25. A system, comprising:
an input interface configured to receive from a search engine information that pertains to at least one document, wherein the at least one document is selected by the search engine in response to at least one search query;
a data structure module, coupled to the input interface, which is configured to divide the at least one document into multiple granular elements in response to content of the at least one document;
a ranking module, coupled to the input interface, which is configured to the granular elements in response to query parameters, and
an output interface, coupled to the ranking module, which is configured to provide, in response to the ranking of the granular elements, search results that comprise at least one of the ranked granular elements.

26. A computer readable medium, having a computer readable code embodied therein for data managing, the computer readable code comprising instructions for:
receiving from a search engine information that pertains to at least one document, wherein the at least one document is selected by the search engine in response to at least one search query;
dividing the at least one document into multiple granular elements in response to content of the at least one document;
ranking the granular elements in response to query parameters, and
providing, in response to the ranking of the granular elements, search results that comprise at least one of the ranked granular elements.
